(19) United States
(12) Patent Application Publication
(10) Pub. No.: US 2014/0017803 A1
(43) Pub. Date: Jan. 16, 2014

(54) DETECTION OF ANALYTES INCLUDING DRUGS

(71) Applicants: Robert Deans, Grafton, MA (US); Aimee Rose, Cambridge, MA (US); William McDaniel, Shrewsbury, MA (US); Aaron Thompson, Tulsa, OK (US); Steven Shaull, Stillwater, OK (US)

(72) Inventors: Robert Deans, Grafton, MA (US); Aimee Rose, Cambridge, MA (US); William McDaniel, Shrewsbury, MA (US); Aaron Thompson, Tulsa, OK (US); Steven Shaull, Stillwater, OK (US)

(73) Assignee: FLIR Systems, Inc., Wilsonville, OR (US)

(21) Appl. No.: 14/007,822

(22) PCT Filed: Mar. 28, 2011
(86) PCT No.: PCT/US2011/030152

§ 371 Date: Sep. 26, 2013

(51) Int. Cl. G01N 21/64

(52) U.S. Cl. CPC G01N 21/6428
USPC 436/172; 422/83

(57) ABSTRACT

Embodiments described herein provide materials, devices, and methods relating to the determination of analytes such as drugs, toxins, explosives, other controlled substances and contraband materials, and the like. In some embodiments, the analyte may be detected in vapor phase. Some embodiments may allow for highly sensitive and essentially instantaneous detection of analytes including drugs.

### FIELD OF THE INVENTION

The present invention relates to compositions, devices, and methods for determination of analytes, including drugs.

### BACKGROUND OF THE INVENTION

Drug detection requires rapid screening of large volumes of people, vehicles, and cargo at airports, seaports, border crossings, and other security checkpoints. Ion mobility spectroscopy (IMS) is currently the most commonly used method for trace drug detection in the field. Due to IMS’ low sensitivity, operators collect trace drug particles by directly swiping suspicious objects or persons. This type of sample collection can be time-consuming, limits throughput, and is subject to operator error. The swipe is then presented to the IMS instrument for analysis. In addition to their low sensitivity and slow throughput, IMS instruments are plagued by other operational limitations. For example, IMS instruments are bulky; contain radioactive sources; require long warm-up times and frequent calibration; are prone to false positives; and typically require substantial clean up after large hits, rendering the instrument out of operation for 1-24 hours.

Canine olfaction is also widely utilized for detecting concealed drugs in the field. Their exquisitely sensitive noses allow them to smell drugs through various types of concealment, while their mobility enables them to screen large areas quickly. While canines offer a superior solution for drug detection, they are expensive to train and maintain, require a full-time handler, can only work for a few hours per day, and do not work for ship boardings. These limitations make meeting current drug detection needs with canines impractical.

Accordingly, improved methods for trace and concealed drug detection are needed.

### SUMMARY OF THE INVENTION

Methods for determination of an analyte are provided. The method may comprise exposing a luminescent sensor material to a sample suspected of containing an amine-containing analyte in vapor phase or a phenol-containing analyte in vapor phase, wherein the amine-containing analyte or the phenol-containing analyte has a vapor pressure less than 880 ppm at 25° C. and 1 atm, and, if present, causes the sensor material to generate a determinable signal; and determining the signal.

In some embodiments, the method may comprise exposing, under a set of conditions, a sensor material having a first determinable signal to a sample suspected of containing an amine-containing analyte or a phenol-containing analyte, wherein the amine-containing analyte or phenol-containing analyte, if present, interacts with the sensor material to generate a second determinable signal from the sensor material, the second determinable signal being different than the first determinable signal; and after exposing, recovering at least 50% of the first determinable signal under said set of conditions in 12 hours or less. In some embodiments, after recovering, the sensor material is exposed to a second sample suspected of containing an amine-containing analyte or a phenol-containing analyte. In some embodiments, the second determinable signal has an amplitude that is decreased relative to the first determinable signal. In some embodiments, the second determinable signal has an amplitude that is increased relative to the first determinable signal.

In any of the embodiments described herein, at least 50%, at least 60%, at least 70%, at least 80%, at least 90%, at least 95%, or at least 99% of the first determinable signal may be recovered under said set of conditions in 12 hours or less. In any of the embodiments described herein, at least 50% of the first determinable signal under said set of conditions may be recovered in 10 hours or less, 5 hours or less, 1 hour or less, 30 minutes or less, 10 minutes or less, 5 minutes or less, 1 minute or less, 30 seconds or less, 10 seconds or less, 5 seconds or less, or 1 second or less.

In any of the embodiments described herein, the determinable signal may be a fluorescence emission.

In any of the embodiments described herein, the analyte may have a vapor pressure less than 880 ppm at 25° C. and 1 atm, less than 500 ppm at 25° C. and 1 atm, less than 250 ppm at 25° C. and 1 atm, less than 100 ppm at 25° C. and 1 atm.

In any of the embodiments described herein, the analyte may be an amine-containing analyte or a phenol-containing analyte. In some embodiments, the amine-containing analyte or phenol-containing analyte is a drug. In some embodiments, the amine-containing analyte or phenol-containing analyte is a controlled substance. The amine-containing analyte may comprise hydrazine, ammonia, aniline, putrescine, cadaverine, skatole, methamphetamine, amphetamine, crack cocaine, cocaine, methylecgonidine, heroin, 3,4-methylenedioxymethamphetamine, oxycodone, morphine, psilocybin, psilocin, LSD, hydrocodone, benzodiazepine, salts thereof, or mixtures thereof. In some embodiments, the analyte is ammonium nitrate, or mixtures comprising ammonium nitrate. In some embodiments, the phenol-containing analyte comprises tetrahydrocannabinol.

In any of the embodiments described herein, the sensor material may comprise a monocyclic or polycyclic aromatic species. In some embodiments, the sensor material comprises a polymer.

In any of the embodiments described herein, the sensor material may comprise a compound having the formula,

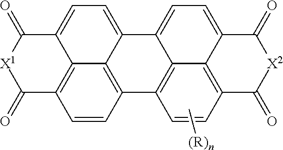

wherein:

each R is independently hydrogen, an aliphatic group, or a heteroaliphatic group, any of which is optionally substituted, or R is a group attached to a polymer;

X¹ and X² are each independently O, S, or NR¹, wherein R¹ is hydrogen, an aliphatic group, or a heteroaliphatic group, any of which is optionally substituted, or R¹ is a group attached to a polymer; and

n is 1-8.

In some embodiments, the sensor material comprises a compound having the formula,

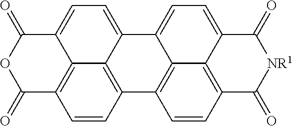

wherein R¹ is alkyl.

In some embodiments, the sensor material comprises a compound having the formula,

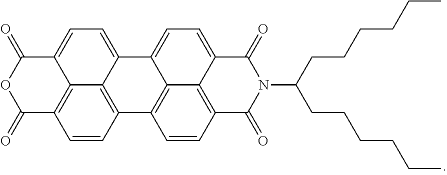 [SMILES: CCCCCCC(CCCCCC)N1C(=O)c2ccc3c4ccc5c6c(ccc(c7ccc(c2c37)C1=O)c64)C(=O)OC5=O]

Devices for determining analyte are also provided. In some embodiments, the device comprises a sample cell constructed and arranged to receive a vapor sample, the sample cell comprising a sensor material capable of interacting with an amine-containing analyte in vapor phase or a phenol-containing analyte in vapor phase, if present in the sample, to generate a determinable signal; and

a detection mechanism positioned to determine the signal,

wherein the sensor material comprises a compound having the formula,

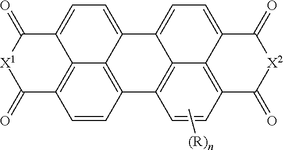

wherein:

each R is independently hydrogen, an aliphatic group, or a heteroaliphatic group, any of which is optionally substituted, or R is a group attached to a polymer;

X¹ and X² are each independently O, S, or NR¹, wherein R¹ is hydrogen, an aliphatic group, or a heteroaliphatic group, any of which is optionally substituted, or R¹ is a group attached to a polymer; and

n is 1-8.

In some embodiments, the device comprises a sample cell constructed and arranged to receive a vapor sample, the sample cell comprising a first region comprising a first sensor material and a second region comprising a second sensor material, wherein at least one of the first and second sensor materials interacts with an amine-containing analyte in vapor phase or a phenol-containing analyte in vapor phase, if present in the vapor sample, to generate a determinable signal; and a detection mechanism positioned to determine the signal, wherein at least one of the first and second sensor materials comprises a compound having the formula,

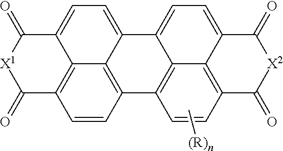

wherein:

each R is independently hydrogen, an aliphatic group, or a heteroaliphatic group, any of which is optionally substituted;

X¹ and X² are each independently O, S, or NR¹, wherein R¹ is hydrogen, an aliphatic group, or a heteroaliphatic group, any of which is optionally substituted; and

n is 1-8.

In any of the foregoing embodiments, the sensor material may comprise a compound having the formula,

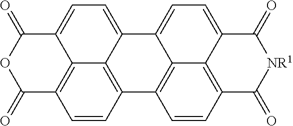

wherein R¹ is alkyl.

In any of the foregoing embodiments, the sensor material may comprise a compound having the formula,

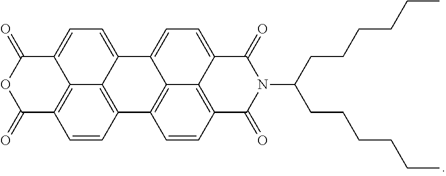 [SMILES: CCCCCCC(CCCCCC)N1C(=O)c2ccc3c4ccc5c6c(ccc(c7ccc(c2c37)C1=O)c64)C(=O)OC5=O]

In any of the foregoing embodiments, the device may further comprising a source of energy. In some embodiments, the source of energy is electromagnetic radiation.

In any of the foregoing embodiments, the sensor material may be in solid form. In some embodiments, the sensor material is a fibrous material. In some embodiments, the sensor material is formed as a thin film on a substrate. In some embodiments, the sensor material is supported on a support material. In some embodiments, the sensor material is evenly dispersed within the support material. In some embodiments, the sensor material is adsorbed and/or absorbed onto the support material. In some embodiments, the sensor material is covalently bonded to the support material. In some embodiments, the sensor material is attached to a polymer. In some embodiments, the sensor material has an emission spectrum between 330-1200 nm. In some embodiments, the sensor material has an emission spectrum between 400-700 nm.

### BRIEF DESCRIPTION OF THE DRAWINGS

FIG. 1 shows a schematic representation of a device for determining an analyte.

FIG. 2 shows examples of amine-containing analytes.

FIG. 3 shows representative data for the fluorescence response of the “modified” Fido® XT system to amphetamine, using (a) “sensor 1” and (b) “sensor 2” of the system.

FIG. 4 show graphs summarizing the fluorescence response for swipe-based detection of (a) amphetamine and (b) methamphetamine.

FIG. 5 shows representative data for the fluorescence response of the “modified” Fido® XT system to samples of (a) amphetamine, (b) methamphetamine, (c) morphine, and (d) heroin.

FIG. 6 shows graphs of both the “modified” Fido® XT response and the MS data upon exposure to GC-based samples of (a) amphetamine, (b) methamphetamine, (c) morphine, and (d) heroin, (e) delta-9 THC, and (f) cannabinol.

FIG. 7 shows a graph of the fluorescence response of the “hybrid” Fido® XT system to the vapor-phase analytes.

FIG. 8 shows a graph of the fluorescence response of the “hybrid” Fido® XT system to the vapor-phase analytes.

FIG. 9 shows graphs of the fluorescence response of both a “hybrid” Fido® XT system and an explosives-only Fido® XT system upon exposure to (a) TNT, (b) RDX, (c) PETN, and (d) nitroglycerin, at various doses (e.g., D, Dx2, Dx3, E, F, G, etc.).

FIG. 10 shows representative data for the fluorescence response of the “hybrid” Fido® XT system upon exposure to amphetamine for (a) the Sensor 1/explosives channel and (b) the Sensor 2/drug channel, at various doses.

FIG. 11 shows graphs of the fluorescence response of the “hybrid” Fido® XT system upon exposure to (a) amphetamine, (b) methamphetamine, (c) morphine, and (d) delta-9 THC, using swipe-based detection.

FIG. 12 shows the fluorescence response (“Fido® Response”) and mass spectrometry response (“MS Response”) of the system upon exposure to (a) crack cocaine, (b) cocaine, (c) heroin, and (d) crystal methamphetamine.

FIG. 13 shows the fluorescence response (“Fido® Response”) of the system upon exposure to vapors in close proximity to (a) a sealed bag of methamphetamine, (b) a taped block of cocaine, (c) a sealed bag of heroin, and (d) a ripped bag of marijuana.

FIG. 14 shows the fluorescence response data of the “modified” Fido® XT system upon exposure to various analytes.

FIG. 15 illustrates, schematically, a sensor material for determining an explosive according to one embodiment.

Other aspects, embodiments and features of the invention will become apparent from the following detailed description when considered in conjunction with the accompanying drawings. The accompanying figures are schematic and are not intended to be drawn to scale. For purposes of clarity, not every component is labeled in every figure, nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### DETAILED DESCRIPTION

Embodiments described herein provide materials, devices, and methods relating to the determination of analytes such as drugs (e.g., narcotics), toxins, explosives, other contraband materials, and the like. In some embodiments, the analyte may be detected in vapor phase. The methods may allow for highly sensitive and essentially instantaneous detection of analytes including drugs. Devices and methods described herein may also allow for fabrication of small, lightweight, portable, low power, hand-held detectors, without the need for complex, regulated, and hazardous components such as a radioactive source. Embodiments described herein may be useful in many applications, including rapid screening of large volumes of cargo, inspection of hidden or closed compartments during ship boardings, and other applications related to security.

Some embodiments provide methods for determination of an analyte. The method may involve, for example, exposing a sensor material to a sample suspected of containing an analyte (e.g., amine-containing analyte or a phenol-containing analyte), wherein the analyte, if present, interacts with the sensor material to generate a determinable signal from the sensor material, thereby determining the analyte. For example, the sensor material may emit a signal in the absence of analyte, where at least one characteristic of the signal is altered (e.g., increased, decreased, shifted, etc.) upon exposure to an analyte. In some cases, the intensity of the signal may decrease in the presence of an analyte. In some cases, the intensity of the signal may increase in the presence of analyte. In some embodiments, the signal may be a luminescence (e.g., fluorescence) emission.

Devices and methods described herein may be particularly advantageous in that analytes having relatively low vapor pressure may be determined in the vapor phase. Many drugs including narcotics and stimulants, for example, are provided in salt form, or other solid form, and typically exhibit very low vapor pressures (e.g., 1.4×10⁻⁶ Torr for cocaine HCl, 0.9×10⁻⁶ Torr for heroin HCl, at 20° C.). The analyte may also be a substance that is placed in a sealed container, mixed or masked with other materials, hidden from sight, and/or otherwise concealed, further reducing the amount of vapor that can be determined. Embodiments described herein allow for rapid, sensitive, vapor phase detection of such analytes. For example, a vapor sample of the air space surrounding or proximate an analyte, or object suspected of containing the analyte, may be tested to determine the analyte (e.g., headpsace sampling). In some embodiments, the analyte may have a vapor pressure less than 880 ppm at 25° C. and 1 atm. In some embodiments, the analyte may have a vapor pressure less than 800 ppm, less than 700 ppm, less than 600 ppm, less than 500 ppm, less than 400 ppm, less than 300 ppm, less than 250 ppm, less than 200 ppm, less than 150 ppm, or less than 100 ppm, at 25° C. and 1 atm.

In one set of embodiments, the analyte may be a drug. The drug may be, in some cases, a controlled substance. As used herein, the term “controlled substance” refers to any substance whose manufacture, possession, and/or use are regulated by a government.

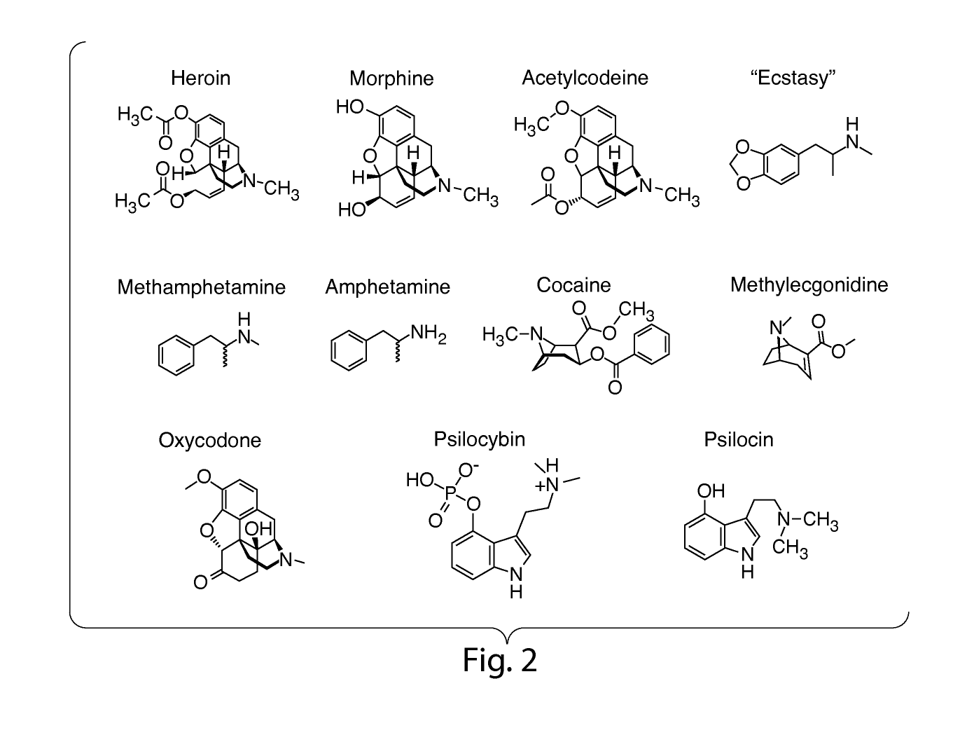

In some embodiments, the drug may be a controlled substance prohibited by governmental regulation. In some embodiments, the drug may be a controlled substance not prohibited by governmental regulation but may be diverted for illicit purposes. For example, the drug may be a controlled prescription drug diverted for illicit purposes (e.g., without prescription). Drugs may include narcotics such as heroin and oxycodone, stimulants such as cocaine and methamphetamine, depressants such as benzodiazepines, hallucinogens such as lysergic acid diethylamide (LSD), cannabis, “bath salts” containing amphetamine-like chemicals such as methylenedioxypyrovalerone, mephedrone and pyrovalerone, and the like. In some embodiments, the drug may be an amine-containing compound. In some embodiments, the drug may be a phenol-containing compound. Examples of drugs include, but are not limited to, tetrahydrocannabinol (or delta-9 THC) as found in marijuana, hashish, hashish oil, or cannabis, methamphetamine, amphetamine, crack cocaine, cocaine, heroin (including black tar heroin), 3,4-methylenedioxymethamphetamine (or Ecstasy), oxycodone, morphine, psilocybin, psilocin (as found in psychedelic mushrooms), lysergic acid diethylamide (LSD), hydrocodone, benzodiazepines, salts thereof, or mixtures thereof, as well as the compounds shown in FIG. 2. It should be understood that the determination of drugs such as narcotics is described herein by way of example only. Other types of vapor phase analytes may also be determined, as described more fully below.

The vapor phase analyte may be determined, in some cases, by direct sampling of the analyte or of an object suspected of containing the analyte, i.e., by analyzing the vapor proximate the analyte or object (e.g., headspace sampling). In some embodiments, a surface of the analyte or object may be physically contacted or swiped (e.g., swipe sampling), and the swipe or vapor proximate the swipe may be analyzed. In some cases, the analyte, object suspected of containing the analyte, or a swipe that has contacted the analyte or object may be placed in a sealed vessel, and the airspace within the vial may be tested. The analyte, object suspected of containing the analyte, or a swipe that has contacted the analyte or object may be treated using various methods prior to, during, and/or after analysis, including heating, cooling, exposure to electromagnetic radiation, and the like. In some cases the analyte, object suspected of containing the analyte, or a swipe that has contacted the analyte or object may be heated. Those of ordinary skill in the art would be able to select the appropriate method for providing the vapor phase analyte based on the desired application.

Some embodiments provide methods and devices for determining analytes in a substantially reversible manner, such that device may be utilized multiple times in the determination of analytes. For example, the device may include a sensor material capable of interacting in substantially reversible manner with an analyte. The interaction between the sensor material and the analyte may comprise formation of a covalent bond, an ionic bond, a hydrogen bond (e.g., between hydroxyl, amine, carboxyl, thiol and/or similar functional groups, for example), a dative bond (e.g., complexation or chelation between metal ions and monodentate or multidentate ligands), or the like, and/or other types of interactions between chemical moieties. In some embodiments, the analyte may interact with the sensor material via electrostatic interactions. In some embodiments, the analyte may interact with the sensor material via biological binding. In some embodiments, the analyte may form a bond (e.g., covalent, non-covalent) with a portion of the sensor material, and the bond may then be broken or cleaved to release the analyte from the sensor material. In some cases, the analyte may be released from the sensor material spontaneously. For example, the sensor material may be exposed to an analyte under a set of conditions, and the analyte may spontaneously be released from the sensor material under the same set of conditions, allowing for repeated use of the device without need for additional processing steps, such as treatment of the sensor material with solvent or other chemical reagents, to regenerate the device. As used herein, exposure to a “set of conditions” may comprise, for example, exposure to a particular temperature, pH, solvent, chemical reagent, type of atmosphere (e.g., ambient air, nitrogen, argon, oxygen, etc.), gas flow rate, electromagnetic radiation, or the like. The sensor material may produce a signal having at least one characteristic that is affected by the presence or absence of analyte. For example, the sensor material may have a first determinable signal in the absence of analyte. The sensor material may then be exposed, under a set of conditions, to a sample suspected of containing an analyte, wherein the analyte, if present, interacts with the sensor material to generate a second determinable signal from the sensor material. In some cases, the second determinable signal has an amplitude that is decreased relative to the first determinable signal. In some cases, the second determinable signal has an amplitude that is increased relative to the first determinable signal. In some embodiments, after being exposed to the analyte, at least 50% of the first determinable signal may be recovered, i.e., to regenerate the sensor material. In some cases, at least 50% of the first determinable signal may be recovered under the same set of conditions as the previous exposing step. That is, the first determinable signal may be spontaneously regenerated under the same set of conditions as the initial exposing step. In some cases, at least 50%, at least 60%, at least 70%, at least 80%, at least 90%, at least 95%, or at least 99% of the first determinable signal is recovered under said set of conditions. The ability to spontaneously recover the original signal of the device after exposure to the analyte has ceased may be advantageous, particularly for use in the field, since the need for timely and complex processing steps to regenerate the sensor material may be eliminated.

It should be understood that some embodiments may involve devices in which a majority of the first determinable signal may not be recovered after being exposed to the analyte. In some cases, less than 50%, less than 40%, less than 30%, less than 20%, less than 15% (e.g., 10%), or less than 10% of the first determinable signal is recovered under said set of conditions. For example, the device may be a one-use, disposable device.

The sensor material may also be selected to have a fast recovery time following a positive test result for an analyte. That is, the sensor material can substantially recover the original signal (e.g., the first determinable signal) and can be ready for exposure to another vapor sample within a relatively short period of time. In some cases, the sensor material can recover at least 50% of the first determinable signal from a positive test result in 12 hours or less, 10 hours or less, 5 hours or less, 1 hour or less, 30 minutes or less, 10 minutes or less, 5 minutes or less, 1 minute or less, 30 seconds or less, 10 seconds or less, 5 seconds or less, or 1 second or less, after exposure to the analyte has ceased.

In some embodiments, sensor material may be a luminescent material. The sensitivity of luminescence-based methods may be advantageous in cases where the analyte is present in low or trace amounts. For example, vapors emanating from drugs are typically present in low amounts, particularly when placed in hidden or closed containers. As used herein, a “luminescent” material refers to a species that can absorb a quantum of electromagnetic radiation to produce an excited state structure and may, in some cases, emit radiation. In some cases, the luminescence may be a fluorescence emission, in which a time interval between absorption and emission of visible radiation ranges from 10⁻¹² to 10⁻⁷ s. In some cases, the luminescence may be phosphorescence, chemiluminescence, electrochemiluminescence, or the like.

In some cases, methods may comprise exposure of a sensor material having a luminescence emission (e.g., a fluorescence emission) to a sample suspected of containing an analyte, and, if present, the analyte interacts with the sensor material to cause a change in the luminescence emission. Determination of the change in the emission may then determine the analyte. In some cases, the change comprises a decrease or increase in luminescence intensity, and/or a change in the wavelength of the luminescence emission. such as a blue-shifted change. As used herein, the term “determining” generally refers to the analysis of a species or signal, for example, quantitatively or qualitatively, and/or the detection of the presence or absence of the species or signals. “Determining” may also refer to the analysis of an interaction between two or more species or signals, for example, quantitatively or qualitatively, and/or by detecting the presence or absence of the interaction. For example, in the absence of analyte, the sensor material may have a first emission, and, upon exposure to the analyte, the analyte interacts with the sensor material to produce a second emission.

In some embodiments, methods of the invention may also comprise determining a change in the luminescence intensity of an emission signal. The change in luminescence intensity may occur for an emission signal with substantially no shift in the wavelength of the luminescence (e.g., emission), wherein the intensity of the emission signal changes but the wavelength remains essentially unchanged. In other embodiments, the change in luminescence intensity may occur for an emission signal in combination with a shift in the wavelength of the luminescence (e.g., emission). For example, an emission signal may simultaneously undergo a shift in wavelength in addition to an increase or decrease in luminescence intensity.

In an illustrative embodiment, the sensor material may contain a luminescent species. Upon exposure of the sensor material to a vapor sample suspected of containing an analyte, such as a drug, the analyte may interact with the sensor material to decrease the intensity of the luminescence emission, thereby signaling the presence and/or amount of analyte present in the sample. After exposure to the analyte has ceased, the sensor material may then be maintained under the same set of conditions as the prior exposing step, and at least 50% of the original luminescence emission (e.g., the luminescence emission prior to exposure to the analyte) may be recovered such that the sensor material may be ready for exposure to another vapor sample. In some embodiments, at least 50% of the original luminescence emission may be recovered within 5 seconds, after exposure to the analyte has ceased.

Some embodiments provide the ability to determine more than one type of analyte using a single device. In some embodiments, the device may include a sample cell including more than one type of sensor material, each being capable of determining a different analyte. For example, the device may include a first sensor material that is responsive to a drug, and a second sensor material that is responsive to an explosive. In some cases, the sensor materials may be arranged such that one sensor material overlays another sensor material. That is, a first sensor material may be formed on the surface of the sample cell, and a second, different sensor material may be formed in contact with and on a surface of the first sensor material. In another embodiment, various sensor materials may be formed on a surface of the sample cell as a mixture. For example, a plurality of sensor materials may be combined in solution, which may then be cast (e.g., spin-cast, drop-cast, etc.) onto the surface of the sample cell.

In some embodiments, the sample cell may include a plurality of different “reaction zones,” with each zone containing a different sensor material. In some cases, the sample cell may include at least two, at least three, at least four, at least five, at least 10, at least 20, at least 30, at least 40, or, in some cases, at least 50 reaction zones. In one set of embodiments, the sample cell includes three reaction zones. In one embodiment, a first sensor material may be formed on a first region of the sample cell and a second sensor material may be formed in a second region of the sample cell, wherein the first and second regions are separate and distinct from each other. In some embodiments, at least one of the first and second sensor materials can interact with an amine-containing or phenol-containing analyte in vapor phase. As an illustrative embodiment, the sample cell may be fabricated to have a first reaction zone containing a sensor material responsive to a drug, and a second reaction zone containing a sensor materials response to an explosive, such as TNT, DNT, PETN, RDX, nitroglycerin, and the like.

Materials capable of determining explosives are known in the art, and are described in, for example, U.S. Pat. No. 7,208,122, entitled, “Emissive Polymers and Devices Incorporating These Polymers”; U.S. Pat. No. 7,041,910, entitled, “Emissive, High Charge Transport Polymers”; U.S. Pat. No. 7,759,127, entitled, “Organic Materials Able To Detect Analytes”; U.S. Publication No. 2005/0147534, entitled, “Emissive Sensors and Devices Incorporating These Sensors”; U.S. Pat. No. 7,700,366, entitled, “Fluorescent, Semi-Conductive Polymers, And Devices Comprising Them”; International Publication No. WO 2008/039529, entitled, “Emissive Polymers and Devices Incorporating These Polymers”; International Publication No. WO 2008/019086, entitled, “Detection of Explosives, Toxins, and Other Compositions”; U.S. Pat. No. 7,666,684, entitled, “Determination of Explosives Including RDX”; and U.S. Pat. No. 7,799,573, entitled, “Detection of Explosives and Other Species,” which patents and publications are incorporated herein by reference in their entirety for all purposes.

In some embodiments, a sensor material may be selected to be responsive to more than one type of analyte. For example, a sensor material may be capable of undergoing a change in an observable signal upon interaction with a drug and with an explosive. In an illustrative embodiment, a single sensor material may be useful in determining ammonium nitrate and at least one drug (e.g., a narcotic).

Some embodiments utilize sensor materials for the determination of analytes, such as amine-containing or phenol-containing analytes. Sensor materials described herein may be provided in various forms, including solid or liquid. In some embodiments, the sensor material may interact (e.g., bind, undergo a chemical reaction, undergo energy transfer) with an analyte molecule, which may either directly generate an observable signal (e.g., light emission) or may initiate a series of chemical events or reactions which may lead to the generation of an observable signal.

The sensor material may be provided in any form, including liquid, solid, gel, and the like. In some cases, the sensor material may be a liquid (e.g., solution, dispersion, emulsion, etc.) In some cases, the sensor material may be a solid (e.g., as a thin film, nanofiber, powder, or other solid form). In some embodiments, the sensor material is a fibrous material, such as a nanofiber. In some embodiments, the sensor material is formed as a thin film on a substrate. In some embodiments, the sensor material is supported on a support material. In some embodiments, the sensor material may be evenly dispersed throughout the support material. In some embodiments, the sensor material may be impregnated within the support material. In some embodiments, the sensor material may be adsorbed and/or absorbed onto the support material. In some embodiments, the sensor material may be combined with other components to form a solution.

Sensor materials may be combined with additional components to produce a sensor material that exhibits a low or negligible vapor pressure and/or a boiling point of at least 300° C. or greater. For example, the sensor material may be combined with other components to produce a sensor material in liquid form, wherein the sensor material has a low or negligible vapor pressure. In some cases, at least one component (e.g., the support material) can be a material having a boiling point at least 300° C. or greater. Examples of such materials include liquids such as dicyclohexyl phthalate and dioctyl terephthalate, and ionic liquids. Sensor materials having low or negligible vapor pressure and/or a high boiling point may be advantageous in reducing or preventing, for example, solvent evaporation, leakage, device contamination, undesirable changes in the optical properties, selectivity, and/or sensitivity of the sensor material, or other disadvantages arising due to use of materials having greater volatility. For example, damage to certain components of the devices (e.g., optics, detectors, pump, seals, O-rings, etc.) due to condensation of volatile materials may be reduced. Some embodiments of the invention may also exhibit enhanced performance (e.g., increased reaction rates) when using a liquid-phase sensor material. The use of sensor materials having low volatility may also facilitate air flow, vapor phase sampling, and vapor phase detecting within devices and methods as described herein.

The sensor material may be selected to be capable of producing a determinable signal. The signal may be, for example, an emission of light. In some embodiments, the sensor material is a luminescent material, including small molecules and dyes, oligomers, polymers, combinations thereof, etc. The use of luminescence (e.g., fluorescence) can provide a highly sensitive, portable method for determination of analytes, circumventing many of limitations of previous drug (e.g., narcotic) detection instruments. The sensor material may be selected to exhibit certain properties, such as a particular emission wavelength, high quantum yield, high output light efficiency, and/or compatibility (e.g., solubility) with one or more components of the device. In some embodiments, the sensor material may be selected to exhibit a high quantum yield. As used herein, the “quantum yield” of a material refers to the total emission produced by the material, i.e., the number of photons emitted per absorbed photon. In some cases, the sensor material may have a quantum yield of at least 10%, at least 20%, at least 30%, at least 40%, at least 50%, at least 75%, at least 90%, at least 95%, or, in some cases, at least 99% or greater. In some embodiments, the light emitting material may be selected to exhibit a high output light efficiency. As used herein, “output light efficiency” of a material refers to the yield of output light (e.g., observable light) produced by the system in the presence of an analyte, i.e., the efficiency of the interaction between the analyte and the sensor material in generating light.

As described herein, the sensor material may have a luminescence emission in the absence of an analyte, and may produce a different luminescence emission in the presence of an analyte. For example, the sensor material may be highly fluorescent in the absence of analyte. Upon interaction with an analyte, such as a drug vapor, the fluorescence of the sensor material may be decreased. In some cases, the fluorescence of the sensor material may be increased upon interaction with an analyte. The sensor material may have a determinable emission of light (e.g., chemiluminescence, fluorescence, phosphorescence), typically with an emission spectrum between 330-1200 nm. In some embodiments, the emission spectrum is between 400-700 nm.

In some cases, the emission may also be visible by sight, e.g., the sensor material may emit visible light. This may allow for the determination of analytes via a colorimetric change. For example, the sensor material, in the absence of analyte, may have a first color, and, upon exposure to an analyte and irradiation by a source of energy, the sensor material may have a second color, wherein the change in color may determine the analyte. In some cases, the signal may be a fluorescence emission.

The sensor material may include one or more groups or materials that are selected to interact with an analyte, including amine-containing or phenol-containing analytes. In some cases, the sensor material may include an electrophilic portion and the analyte may include a nucleophilic portion. For example, the sensor material may include an anhydride moiety, which may undergo nucleophilic attack by an amine-containing or phenol-containing analyte. In some cases, the sensor material may include a nucleophilic portion and the analyte may include an electrophilic portion. In some embodiments, the sensor material and analyte may include positively-charged and/or negatively charged portions, such that the sensor material and analyte interact via electrostatic interactions. In some embodiments, the sensor material may be selected to accept electrons, e.g., from an analyte. For example, the sensor material comprises an n-type, electron-accepting, organic semiconductor, such as N-(1-hexylheptyl)perylene-3,4,9,10-tetracarboxyl-3,4-anhydride-9,10-imide. In some embodiments, the sensor material may be selected to donate electrons, e.g., to an analyte.

The sensor material may also include one or more groups or materials that are selected to enhance solubility of the sensor material. For example, the sensor material, and components thereof, may be selected to be soluble with respect to a solvent or other carrier to form mixtures (e.g., solutions). In some embodiments, the sensor material may comprise a compound having various hydrophobic groups (e.g., alkyl groups) that enhance solubility in organic solvents. In some cases, the sensor material includes groups that may allow for formation of fibers (e.g., macrofibers, nanofibers).

In some embodiments, the sensor material may comprise a rigid, shape-persistent portion which may improve various properties of the materials including solubility and/or emissive properties of the materials. As used herein, a “shape-persistent portion” of a molecule is a portion having a molecular weight of at least 15 g/mol and having a significant amount of rigid structure, as understood by those of ordinary skill in the art. As used herein, a “rigid” structure means a structure, the ends of which are separated by a distance which cannot change (outside of normal molecule-scale changes in temperature, etc.) without breaking at least one bond, as understood by those of ordinary skill in the art. In some embodiments, the shape-persistent portion may have a molecular weight of at least 25, 50, or 100 g/mol. Generally, the shape-persistent portion may not move relative to other portions of the molecule via, for example, rotation about a single bond. For example, the shape-persistent portion may comprise an aromatic ring structure fused to a portion of the polymer via two adjacent atoms of the polymer, such that the shape-persistent portion may not rotate relative to the two adjacent atoms of the polymer.

Shape-persistent structures may be provided, for example, by aromatic groups, bridged, bicyclic and polycyclic structures, and the like. For example, an iptycene molecule is a shape-persistent portion. By contrast, a molecule including a cyclic structure such as a benzene ring connected to another portion of the molecule via only a single bond, such as in a biphenyl group, has at least a portion of the molecule that is not shape-persistent, since a benzene ring can rotate about a single bond. Some examples of shape-persistent portions include planar structures, such as aromatic groups (e.g., benzenes, naphthalenes, pyrenes, etc.). The aromatic groups may be rigidly bonded to (e.g., fused to) the sensor material, i.e., the aromatic group is bonded to the sensor material via two covalent bonds at adjacent positions on the aromatic ring. In some cases, the shape-persistent portion includes a non-planar structure, such as a bicyclic or polycyclic structure wherein bridgehead atoms are not positioned adjacent to one another within the molecule. Examples include adamantanes, norbornenes, iptycenes, and the like. In one embodiment, the shape-persistent portion comprises a bicyclic ring system that is non-planar (e.g., an iptycene).

In some embodiments, the sensor material may comprise an iptycene. An iptycene typically comprises arene planes fused together via at least one cyclooctane moiety. Examples of iptycenes include triptycenes (3 arene planes) and pentiptycenes (5 arene planes). For example, the sensor material may comprise anthracene covalently bonded to an iptycene. In one embodiment, the sensor material is anthracene, diphenylanthracene, 9,10-bis(phenylethynyl)anthracene, or a material comprising anthracene covalently bonded to an iptycene. In one embodiment, the sensor material is 9,10-bis(phenylethynyl)-anthracene, or a substituted derivative thereof.

In some embodiments, the sensor material may be a conjugated polymer, such as poly(phenylene-ethynylene), poly(phenylene-vinylene), polyp-phenylene), polythiophene, other poly(arylene)s, substitute derivatives thereof, and the like. The emissive capability of such polymers are known in the art, and can be selected to suit a particular application.

Some embodiments involve the use of a sensor material comprising a monocyclic or polycyclic aromatic species, which may be substituted or unsubstituted. The monocyclic or polycyclic aromatic species may be a small molecule or may be attached to a polymeric species (e.g., may be part of a polymer backbone, or may be attached to a polymer backbone as a pendant side group). Examples of monocyclic or polycyclic aromatic species include phenyl, naphthyl, anthracenyl, chrysenyl, fluoranthenyl, fluorenyl, phenanthrenyl, pyrenyl, perylenyl, and the like. The monocyclic or polycyclic aromatic species may also include one or more heteroatom ring atoms (e.g., heteroaromatic species). In some embodiments, the monocyclic or polycyclic aromatic species may be appropriately substituted to produce a luminescent material.

In one set of embodiments, the sensor material comprises a perylene-based compound. For example, the sensor material may comprise a compound having the formula,

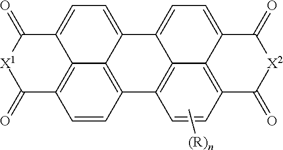

wherein:

each R is independently hydrogen, an aliphatic group, or a heteroaliphatic group, any of which is optionally substituted, or R is a group attached to a polymer;

X¹ and X² are each independently O, S, or NR¹, wherein R¹ is hydrogen, an aliphatic group, or a heteroaliphatic group, any of which is optionally substituted, or R¹ is a group attached to a polymer; and

n is 1-8.

In one set of embodiments, the sensor material comprises a compound having the formula,

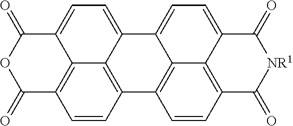

wherein R¹ is alkyl.

In one set of embodiments, the sensor material comprises a compound having the formula,

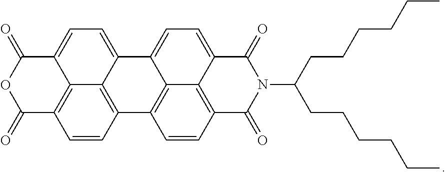 [SMILES: CCCCCCC(CCCCCC)N1C(=O)c2ccc3c4ccc5c6c(ccc(c7ccc(c2c37)C1=O)c64)C(=O)OC5=O]

The sensor material may optionally include other components which may enhance the stability and/or performance of the sensor material. In some embodiments, the sensor material further comprises a species or group which facilitates the interaction of the sensor material with the analyte molecule. In some embodiments, the sensor material further comprises an acid, base, buffer, catalyst, or the like. In some cases, the sensor material comprises a material capable of reducing background signal caused by, for example, impurities present within the sample. For example, the sensor materials may further comprise an absorbent material, which may reduce the amount of impurities from the sample (e.g., “clean” or “scrub” the sample). This “cleaning” process may enhance the sensitivity and/or selectivity of the sensor material for a particular analyte. The sensor material may also be combined with a support material, as described more fully below.

Various analytes may be determined using the methods and devices described herein. In some cases, the analyte may be a species having vapor pressure less than 880 ppm at 25° C. and 1 atm. The analyte may be in solid form, such as a salt. It should be understood that embodiments described herein may also include determination of analytes having relatively high vapor pressures, including starting materials, by-products, and final products of analytes including explosives and drugs (e.g., narcotics). For example, it may be desirable in one set of embodiments to determine starting materials, by-products, and final products of clandestine labs, such as clandestine methamphetamine labs (e.g., ammonia, methylamine, and methamphetamine free base), or the like. In another embodiment, it may be desirable to determine the degradants of certain drugs, such as methylecgonidine, which can be generated from cocaine.

Some embodiments involve determination of an analyte comprising a group capable of interacting with the sensor material. In some embodiments, the analyte may comprise a nucleophilic group, such as an amine or a phenol, which may interact with an electrophilic portion of the sensor material (e.g., an anhydride moiety). In some embodiments, the analyte is an amine-containing analyte. As used herein, the term “amine-containing analyte” refers to a species comprising an “—NR” group, wherein each R is independently hydrogen or another atom or group. The amine-containing analyte may include an unsubstituted amine (e.g., —NH₂), a monosubstituted amine (e.g., —NHR where R is not hydrogen), or a disubstituted amine (e.g., NR₂ where R is not hydrogen), a salt, or the like. In some embodiments, the amine-containing analyte refers to a species comprising a urea group (e.g., —R₂NCONR₂). In some embodiments, the amine-containing analyte may be a drug. In some embodiments, the amine-containing analyte may be a controlled substance. In some embodiments, the amine-containing analyte may be a narcotic. Examples of amine-containing analytes include hydrazine, ammonia, aniline, putrescine, cadaverine, skatole, methamphetamine, amphetamine, crack cocaine, cocaine, methylecgonidine, heroin (including black tar heroin), 3,4-methylenedioxymethamphetamine (or Ecstasy), oxycondone, morphine, psilocybin, psilocin (as found in psychedelic mushrooms), salts thereof (e.g., ammonium nitrate), or mixtures thereof. In one set of embodiments, the analyte may be ammonium nitrate, or mixtures comprising ammonium nitrate (e.g., ammonium nitrate/fuel oil or “ANFO”).

In some embodiments, the analyte is a phenol-containing analyte. As used herein, the term “phenol-containing analyte” refers to a species comprising an “ArOH” group, where “Ar” is an aryl group. In some embodiments, the amine-containing analyte may be a drug. In some embodiments, the amine-containing analyte may be a controlled substance. In some embodiments, the amine-containing analyte may be a narcotic. An example of a phenol-containing analyte is tetrahydrocannabinol (or “Δ⁹-THC”), found in marijuana, hashish, or cannabis.

Other analytes may be determined using the methods and devices described herein. In some embodiments, the analyte may be a toxin, or other environmental hazard. For example, the sensor material may be responsive to cadaverine (or NH₂(CH₂)₅NH₂) or putrescine (or NH₂(CH₂)₄NH₂). Determination of such analytes may be useful, for example, in identifying the locations of people that may be trapped under rubble as a consequence of a natural disaster.

Some embodiments may involve the combination of a sensor material with a support material. The support material may be any material (e.g., liquid, solid, etc.) capable of supporting (e.g., containing) the components of the sensor materials described herein. For example, the support material may be selected to have a high boiling point, such as a boiling point of at least 300° C. or greater, or, in some cases, at least 400° C., 500° C., or greater. The support material may also be selected to have low vapor pressure. In some cases, the support material may be a material that may remain in the solid state at room temperature (e.g., 25° C.) but may undergo transition to a liquid state at temperatures lower than or at the operating temperature of the device. In some cases, the support material may be selected to have a particular surface area wherein the support material may absorb or otherwise contact a sufficient amount of analyte (e.g., a drug, an explosive) to allow interaction between the analyte and, for example, the sensor material. In some embodiments, the support material has a high surface area. In some cases, the support material has a surface area of at least 50 mm², at least 100 mm², at least 200 mm², at least 300 mm², at least 400 mm², or, more preferably, at least 500 mm². In one embodiment, the support material may be filter paper having a surface area of at least 50 mm², or as otherwise described herein.

In some embodiments, the support material may preferably have a low background signal, substantially no background signal, or a background signal which does not substantially interfere with the signal generated by the sensor material in the presence of an analyte (e.g., an amine-containing analyte). In some cases, the support material may have a preferred pH to prevent undesirable reactions with, for example, an acid. The support material may be soluble, swellable, or otherwise have sufficient permeability in sensor materials of the invention to permit, for example, intercalation of the sensor material within the support material. In one embodiment, the support material may be hydrophobic, such that a hydrophobic solution containing the sensor material may diffuse or permeate the support material. Additionally, the support material may preferably permit efficient contact between the sample (e.g., amine-containing analyte) to be determined and the sensor material. For example, in one embodiment, a vapor comprising an amine-containing analyte may permeate the support material to interact with the sensor material. The permeability of certain support materials described herein are known in the art, allowing for the selection of a particular support material having a desired diffusion. The choice of support material may also affect the intensity and duration of, for example, light emission from the sensor material.

In some cases, the support material may be a liquid, such as liquid having low volatility or a low or negligible vapor pressure. Use of a liquid support material may, in some cases, enhance the interaction between the analyte and the sensor material by providing sensor materials in a homogeneous solution. The liquid may have a boiling point of at least 300° C., at least 400° C., at least 500° C., or greater. As used herein, the “boiling point” refers to the boiling point of a material at atmospheric pressure (e.g., about 1 atm). Examples of liquid support materials (e.g., solvents) include, but are not limited to, dicyclohexyl phthalate or dioctyl terephthalate. In some cases, the solvent may be an ionic liquid. As used herein, the term “ionic liquid” is given its ordinary meaning in the art and refers to a liquid comprising primarily ionic species. That is, at equilibrium, greater than 90% of species in an ionic liquid may be ionic. In some embodiments, greater than 99%, or, greater than 99.9%, of species in an ionic liquid may be ionic. In some cases, the ionic liquid is a salt. Examples of ionic liquids include ethylammonium nitrate and imidazolium salts.

In some cases, the support material may be a liquid crystal.

In some cases, the support material may be a solid. Examples of solid support materials include glass supports, polymers, copolymers, gels, solid adsorbent materials such as Kim Wipes® and filters. In some embodiments, the support material may be a finely divided powder, particles, molded shapes such as beads, films, bottles, spheres, tubes, strips, tapes, and the like. The support material may be glass wool, glass filter paper, filter paper, nylon filters, and the like. In one embodiment, the support material is a powder. In one embodiment, the support material is a silica. In some embodiments, the sensor material may have a shape or be formed into a shape (for example, by casting, molding, extruding, and the like). In some embodiments, the support material may be a film, a bottle, a sphere, a tube, a strip such as an elongated strip or tape, or the like.

In some embodiments, the support material may be a polymer. Examples include polyethylene, polypropylene, poly(vinyl chloride), poly(methyl methacrylate), poly(vinyl benzoate), poly(vinyl acetate), cellulose, corn starch, poly(vinyl pyrrolidinone), polyacrylamide, epoxys, silicones, poly(vinyl butyral), polyurethane, nylons, polacetal, polycarbonate, polyesters and polyethers, crosslinked polymers such as polystyrene-poly(divinyl benzene), polyacrylamide-poly(methylenebisacrylamide), polybutadiene copolymers, combinations thereof, and the like.

The combination of support material and solvent may have a desired diffusion rate, controlling the intensity and duration of light emission. The permeability of a particular polymer is known in the art. Examples include polystyrene-poly(divinyl benzene) copolymer and ethylbenzene, poly(vinyl chloride) and ethyl benzoate, and poly(methyl methacrylate) and dimethylphthalate.

The support material may be formed in a variety of ways. The flexibility of the materials may be tuned to fit a desired application by methods known in the art. For example, the addition of plasticisizers, or use of a rubber base, such as silicone. The usual monomeric and preferably oligomeric plasticizers known in the state of the technology can be used within the meaning of the invention, alone or mixed with the polymeric plasticizers. These are, for example, phthalates (phthalic acid esters) such as dioctyl phthalate (DOP), diisononyl phthalate (DINP), diisodecyl phthalate (DIDP), dibutyl phthalate (DBP), diisobutyl phthalate (DIBP), dicyclohexyl phthalate (DCHP), dimethyl phthalate (DMP), diethyl phthalate (DEP), benzyl-butyl phthalate (BBP), butyl-octyl phthalate, butyl-decyl phthalate, dipentyl phthalate, dimethylglycol phthalate, dicapryl phthalate (DCP) and the like; trimellitates, such as, in particular, trimellitic acid esters with (predominantly) linear C₆ to C₁₁ alcohols with low volatility and good cold elasticity, acyclic (aliphatic) dicarboxylic acid esters, such as, in particular, esters of adipic acid, such as dioctyl adipate (DOA), diisodecyl adipate (DIDA), especially mixed with phthalates; dibutylsebacate (DBS), dioctyl sebacate (DOS) and esters of azelaic acid, especially mixed with phthalates, dibutyl sebacate; oligomeric plasticizers such as polyesters of adipic, sebacic, azelaic and phthalic acid with diols such as 1,3-butanediol, 1,2-propanediol, 1,4-butanediol, and 1,6-hexanediol, and with triols such as, especially, glycerin and more highly functional alcohols, phosphates (phosphoric acid esters), especially tricresyl phosphate (TCP), triphenyl phosphate (TPP), diphenyl cresyl phosphate (DPCP), diphenyloctyl phosphate (DPOP), tris-(2-ethylhexyl) phosphate (TOP), tris-2-butoxyethyl) phosphate, fatty acid esters, such as, in particular, butyl stearate, methyl and butyl esters of acetylated ricinol fatty acid, triethylene glycol-bis-(2-ethylbutyrate), hydroxycarboxylic acid esters such as, in particular, citric acid esters, tartaric acid esters, lactic acid esters, epoxide plasticizers, such as, in particular, epoxidized fatty acid derivatives, especially triglycerides and monoesters, and the like, such as are known particularly as PVC plasticizers. In this connection, please see Rompp Chemie Lexikon, 9th Ed., Vol. 6, 1992, pp. 5017-5020, the contents of which are incorporated herein by reference for all purposes.

Other embodiments provide devices for the determination (e.g., detection) of analytes including drugs. In some cases, the devices may eliminate the need for complex components such as delicate optics configurations, high power lasers, complex sampling apparatuses, external means for photodetection and signal amplification (e.g., a photomultiplier tube), and the like. Some embodiments may advantageously provide simplified devices that are amenable to in-field use.

In one embodiment, a device may comprise an inlet for intake of a vapor sample, a sample cell comprising the sensor material, the sample cell constructed and arranged to receive the vapor sample, and a detection mechanism positioned to receive and detect signal (e.g., an optical signal) from the sample cell. As used herein, a sample cell “constructed and arranged” refers to a sample cell provided in a manner to direct the passage of a vapor sample, such as a vapor comprising a drug, from the inlet into the sample cell, such that the vapor sample contacts at least the sensor material. In some embodiments, the detection mechanism may be in optical communication with the sample cell, i.e., may receive and detect an optical signal (e.g., emission) from the sample cell. In some cases, the detection mechanism may comprise a photodiode. In some cases, the device further comprises additional components, such as a component for reducing or otherwise controlling the amount of ambient light which enters the sample cell.

Embodiments described herein may also include one or more components which may enhance the performance of the device. The component may be a source of energy which, when applied to the sensor material, is capable of generating a signal from the sensor material. The source of energy may be thermal, electric, magnetic, optical, acoustic, electromagnetic, mechanical or the like. In some cases, the source of energy may be electromagnetic radiation, such as ultraviolet light or visible light. In some embodiments, the electromagnetic radiation has a wavelength of 350 nm or less, or, more preferably, 254 nm or less, or 200 nm or less. In some embodiments, the device may include a component capable of heating or cooling the vapor phase sample prior to contact with the sensor material.

The device may be suitable as, for example, a hand-held device for screening high volumes of people and/or containers. In some cases, the device may be similar in appearance to devices disclosed in U.S. Pat. No. 6,558,626, incorporated herein by reference. In some cases, devices of the present invention provide a detector and sensor assembly suitable for the detection of amine-containing or phenol-containing analytes, or other analytes, including drugs (e.g., narcotics), toxins, explosives, or combinations thereof.

In one set of embodiments, the device may include a sample cell as described herein, a sampling system (e.g., a pump to draw the vapor sample into the device), an LED, a photodetector with appropriate optics, and operational software.

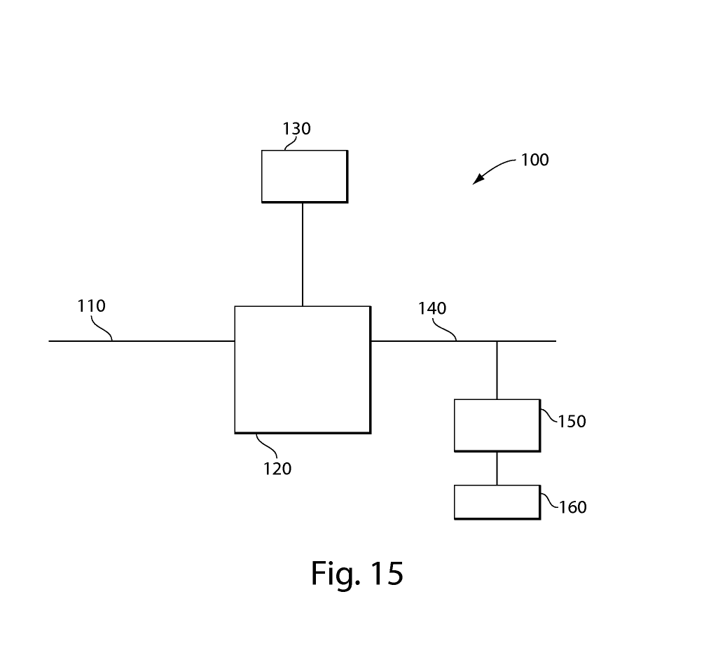

FIG. 15 illustrates, schematically, a sensor material for determining an explosive according to one embodiment. A device 100 comprises an inlet 110 for intake of a vapor sample. Inlet 110 is connected to sample cell 120, which may comprise sensor materials as described herein, such that a vapor sample entering sample cell 120 via inlet 110 may contact the sensor material. Sample cell 120 may be constructed and arranged so that the vapor sample may pass across, over, or through the sensor material, or in some way contact the sensor material. A detector 130 is provided in optical communication with (e.g., connected to) sample cell 120 such that any light emitting from sample cell 120 may be collected, filtered, viewed, and/or stored/displayed by the detector. The detector may comprise a photomultiplier tube, a photodiode, or any apparatus for viewing the light emitted from sample cell 120. The detector may be configured to detect a particular range of emission, such as 400-700 nm (e.g., visible light), or 400-500 nm, or the like. The vapor sample may be removed from sample cell 120 via an outlet 140 connected to sample cell 120. Pump 150 may be connected to outlet 140 to remove the vapor sample from sample cell 120. Also, an out flow meter 160 may be used to regulate pump 150.

The inlet and outlet may be made of materials known in the art, such as polymer, metal, or other materials which may be inert to the vapor sample and/or otherwise suitable for constructing the device. Those of ordinary skill in the art, with the benefit of this disclosure, can readily select appropriate materials and construct a suitable sensor material without undue experimentation.

Other examples of device designs suitable for use in the present invention are described in U.S. Pat. No. 7,799,573, entitled, “Detection of Explosives and Other Species,” the contents of which are incorporated herein by reference in its entirety for all purposes.

As described herein, devices of the invention may comprise a sample cell (e.g., capillary) in which sensor materials of the invention may be contained. The sample cell may be constructed to provide sufficient surface area within the sample cell to promote interaction of the sensor material with an analyte. The sample cell may also contain the sensor material as a homogeneous and stable solution, dispersion, film, etc. In some cases, the sample cell may be selected to comprise a material that is substantially non-reactive with and non-degraded by one or more components of the sensor material. In some cases, the sample cell may be treated (e.g., with silane and/or acid) to improve the shelf operational life of the sensor material. Some examples of such treatments are described in U.S. Pat. No. 3,974,368, incorporated herein by reference.

The sample cell may be formed from any material having sufficient optical transparency (e.g., glass) such that a signal may be determined from the sensor material. The sample cell may have any shape or dimension suitable for use in a particular application. In some embodiments, the sample cell may be a transparent glass tube or capillary, which may be chemically etched to improve adhesion of the sensor material. The capillary may optionally include irregular surfaces, including a serrated or fluted surface, for example. In some cases, when the sample cell is a glass capillary, the sensor material may be spin-coated on the interior of the capillary in liquid form. In some cases, the capillary may have a length of about 4.5 cm to about 7.5 cm and an internal diameter of 0.6 mm. However, it should be understood that the size of the capillary is not considered to be limiting, with sizes ranging from small capillary sizes to larger diameters (e.g., tubes) suitable for use in stationary devices. Suitable glass capillaries may be prepared from quartz, borosilicate, soda lime glass, flint glass and other similar naturally occurring and synthetic materials.

In some embodiments, the sample cell may be a substrate on which a plurality of printed “dots” may be formed, with each “dot” comprising a sensor material. In some cases, each individual “dot” may comprise a different sensor material. In some cases, a first set of “dots” may have a sensor material that is different than a second set of “dots.”It should be understood that the number and/or types of sensor materials may be selected and arranged on or in the substrate to suit a particular, desired application. In some cases, the substrate is substantially flexible. In some cases, the substrate is substantially rigid. Examples of materials suitable for use as a substrate include polyethylene terephthalate, polyethylene terephthalate glycol, polyethylene naphthalate, cyclo-olefin polymer, polycarbonate, polyimide, cellulose acetate, cellulose triacetate, acrylics, styrenes, and combinations thereof. Other examples are described in International Application Serial No. PCT/US2010/60321, filed Dec. 14, 2010, entitled “Multi-analyte Detection System and Method,” the contents of which application are incorporated herein by reference in its entirety for all purposes.

In some embodiments, the sensor material is formed on the surface of the capillary as a fibrous material. The fibrous material may be, for example, nanofibers. In some cases, the sensor material is formed as a thin film on the surface of the capillary. Typically, the sample cell includes a sufficient layer of the sensor material to interact with a vapor phase analyte and to generate detectable light. The layer comprising the sensor material may have any thickness suitable for a particular application. In some cases, the layer of the sensor material may be between about 2 μm and about 10 μm thick, or greater. In some embodiments, the capillary may contain about 2 μL of sensor material such that the interior of the capillary defines a reaction zone. In some embodiments, the capillary may include more than one reaction zone, with each zone containing a sensor material responsive to a different analyte.

In some cases, the sample cell may include additional components in order to increase the surface area of the reaction zone. For example, the sample cell may include beads (e.g., polymeric beads, glass beads, etc.) or other materials, optionally having irregular surfaces (e.g., serrated or fluted surfaces) placed within the sample cell. In some embodiments, the sample cell may include glass beads coated with the sensor material and positioned within the samples cell, which can also be coated with the sensor material. In general, any material which permits passage of gas without reacting therewith may be suitable for use in sample cells in the present invention. In one embodiment, the glass capillary may be transparent to the emission produced by the sensor material, thereby permitting detection by an optical detector. As described herein, the interior of the capillary may define the reaction zone 50. In some cases, the capillary may have a length of about 4.5 cm to about 7.5 cm and an internal diameter of 0.6 mm. Suitable glass capillaries may be prepared from quartz, borosilicate, soda lime glass, flint glass and other similar naturally occurring and synthetic materials.

The addition of glass beads, or other suitable materials, to the sample cell may increase the effective surface area of the sample cell, thereby allowing an increased volume of the sensor material within the reaction zone. The volume of the sensor material carried by beads may be sufficient to generate a detectible signal when exposed to vapor phase analyte. Typically, the amount of the sensor material may be from about 40 μL to about 60 μL. In some cases, the sample cell is a glass capillary comprising glass beads contained within the glass capillary, such that the interior of the capillary and the surface of the glass beads define the area of the reaction zone. In some cases, the sample cell may contain about 50 μL of the sensor material.

Additionally, the capillary and beads may be heat treated, i.e. sintered, to mechanically fuse the beads to the capillary. The capillary, beads, or fused bead/capillary configuration may be optionally treated to improve surface adhesion to prolong the luminescence lifetime of the sensor material. For example, silane treatments and/or acid etching of the glass walls may enhance the adhesion of polymers to the walls of glass beads and capillaries, or may otherwise improve capillary performance.

The sample cell may have any shape, size, or other characteristic suitable for use in a particular application, such that the sample cell provides sufficient surface area for interaction between an analyte and the sensor material. In some cases, the sample cell may be easily replaceable. For example, a removable capillary having an interior coated with the sensor material or comprising beads coated with the sensor material may be useful in embodiments of the invention.

Devices as described herein may be useful in methods for the determination of amine-containing or phenol-containing analytes and other drugs (e.g., narcotics). In some cases, the devices may be hand-held and/or portable, and may be used in a field environment such as airport security and field checkpoints. The devices may be fabricated using various methods, including those described in U.S. Pat. No. 7,799,573, entitled, “Detection of Explosives and Other Species,” the contents of which patent are incorporated herein by reference in its entirety.

Definitions of specific functional groups and chemical terms are described in more detail below. For purposes of this invention, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito, 1999, the entire contents of which are incorporated herein by reference.

It will be appreciated that the compounds, as described herein, may be substituted with any number of substituents or functional moieties. In general, the term “substituted” whether preceded by the term “optionally” or not, and substituents contained in formulas of this invention, refer to the replacement of hydrogen radicals in a given structure with the radical of a specified substituent. When more than one position in any given structure may be substituted with more than one substituent selected from a specified group, the substituent may be either the same or different at every position. As used herein, the term “substituted” is contemplated to include all permissible substituents of organic compounds. In a broad aspect, the permissible substituents include acyclic and cyclic, branched and unbranched, carbocyclic and heterocyclic, aromatic and nonaromatic substituents of organic compounds. For purposes of this invention, heteroatoms such as nitrogen may have hydrogen substituents and/or any permissible substituents of organic compounds described herein which satisfy the valencies of the heteroatoms. Furthermore, this invention is not intended to be limited in any manner by the permissible substituents of organic compounds. Combinations of substituents and variables envisioned by this invention are preferably those that result in the formation of stable materials. The term “stable”, as used herein, preferably refers to compounds which possess stability sufficient to allow manufacture and which maintain the integrity of the compound for a sufficient period of time to be detected and preferably for a sufficient period of time to be useful for the purposes detailed herein.

The term “aliphatic”, as used herein, includes both saturated and unsaturated, straight chain (i.e., unbranched), branched, acyclic, cyclic, or polycyclic aliphatic hydrocarbons, which are optionally substituted with one or more functional groups. As will be appreciated by one of ordinary skill in the art, “aliphatic” is intended herein to include, but is not limited to, alkyl, alkenyl, alkynyl, cycloalkyl, cycloalkenyl, and cycloalkynyl moieties. Thus, as used herein, the term “alkyl” includes straight, branched and cyclic alkyl groups. An analogous convention applies to other generic terms such as “alkenyl”, “alkynyl”, and the like. Furthermore, as used herein, the terms “alkyl”, “alkenyl”, “alkynyl”, and the like encompass both substituted and unsubstituted groups. In certain embodiments, as used herein, “lower alkyl” is used to indicate those alkyl groups (cyclic, acyclic, substituted, unsubstituted, branched or unbranched) having 1-6 carbon atoms.

In certain embodiments, the alkyl, alkenyl, and alkynyl groups employed in the invention contain 1-20 aliphatic carbon atoms. In certain other embodiments, the alkyl, alkenyl, and alkynyl groups employed in the invention contain 1-10 aliphatic carbon atoms. In yet other embodiments, the alkyl, alkenyl, and alkynyl groups employed in the invention contain 1-8 aliphatic carbon atoms. In still other embodiments, the alkyl, alkenyl, and alkynyl groups employed in the invention contain 1-6 aliphatic carbon atoms. In yet other embodiments, the alkyl, alkenyl, and alkynyl groups employed in the invention contain 1-4 carbon atoms. Illustrative aliphatic groups thus include, but are not limited to, for example, methyl, ethyl, n-propyl, isopropyl, cyclopropyl, —CH₂-cyclopropyl, vinyl, allyl, n-butyl, sec-butyl, isobutyl, tert-butyl, cyclobutyl, —CH₂-cyclobutyl, n-pentyl, sec-pentyl, isopentyl, tert-pentyl, cyclopentyl, —CH₂-cyclopentyl, n-hexyl, sec-hexyl, cyclohexyl, —CH₂-cyclohexyl moieties and the like, which again, may bear one or more substituents. Alkenyl groups include, but are not limited to, for example, ethenyl, propenyl, butenyl, 1-methyl-2-buten-1-yl, and the like. Representative alkynyl groups include, but are not limited to, ethynyl, 2-propynyl (propargyl), 1-propynyl, and the like.

The term “heteroaliphatic”, as used herein, refers to aliphatic moieties that contain one or more oxygen, sulfur, nitrogen, phosphorus, or silicon atoms, e.g., in place of carbon atoms. Heteroaliphatic moieties may be branched, unbranched, cyclic or acyclic and include saturated and unsaturated heterocycles such as morpholino, pyrrolidinyl, etc. In certain embodiments, heteroaliphatic moieties are substituted by independent replacement of one or more of the hydrogen atoms thereon with one or more moieties including, but not limited to aliphatic; heteroaliphatic; aryl; heteroaryl; arylalkyl; heteroarylalkyl; alkoxy; aryloxy; heteroalkoxy; heteroaryloxy; alkylthio; arylthio; heteroalkylthio; heteroarylthio; —F; —Cl; —Br; —I; —OH; —NO₂; —CN; —CF₃; —CH₂CF₃; —CHCl₂; —CH₂OH; —CH₂CH₂OH; —CH₂NH₂; —CH₂SO₂CH₃; —C(O)Rₓ; —CO₂(Rₓ); —CON(Rₓ)₂; —OC(O)Rₓ; —OCO₂Rₓ; —OCON(Rₓ)₂; —N(Rₓ)₂; —S(O)₂Rₓ; —NR_{R}(CO)R_{R}, wherein each occurrence of Rₓ independently includes, but is not limited to, aliphatic, heteroaliphatic, aryl, heteroaryl, arylalkyl, or heteroarylalkyl, wherein any of the aliphatic, heteroaliphatic, arylalkyl, or heteroarylalkyl substituents described above and herein may be substituted or unsubstituted, branched or unbranched, cyclic or acyclic, and wherein any of the aryl or heteroaryl substituents described above and herein may be substituted or unsubstituted. Additional examples of generally applicable substitutents are illustrated by the specific embodiments shown in the Examples that are described herein

Unless otherwise indicated, as used herein, the terms “alkyl”, “alkenyl”, “alkynyl”, “heteroalkyl”, “heteroalkenyl”, “heteroalkynyl”, “alkylidene”, alkenylidene”, -(alkyl)aryl, -(heteroalkyl)aryl, -(heteroalkyl)aryl, -(heteroalkyl)heteroaryl, and the like encompass substituted and unsubstituted, and linear and branched groups. Similarly, the terms “aliphatic”, “heteroaliphatic”, and the like encompass substituted and unsubstituted, saturated and unsaturated, and linear and branched groups. Similarly, the terms “cycloalkyl”, “heterocycle”, “heterocyclic”, and the like encompass substituted and unsubstituted, and saturated and unsaturated groups. Additionally, the terms “cycloalkenyl”, “cycloalkynyl”, “heterocycloalkenyl”, “heterocycloalkynyl”, “aromatic”, “heteroaromatic, “aryl”, “heteroaryl” and the like encompass both substituted and unsubstituted groups.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

### Example 1

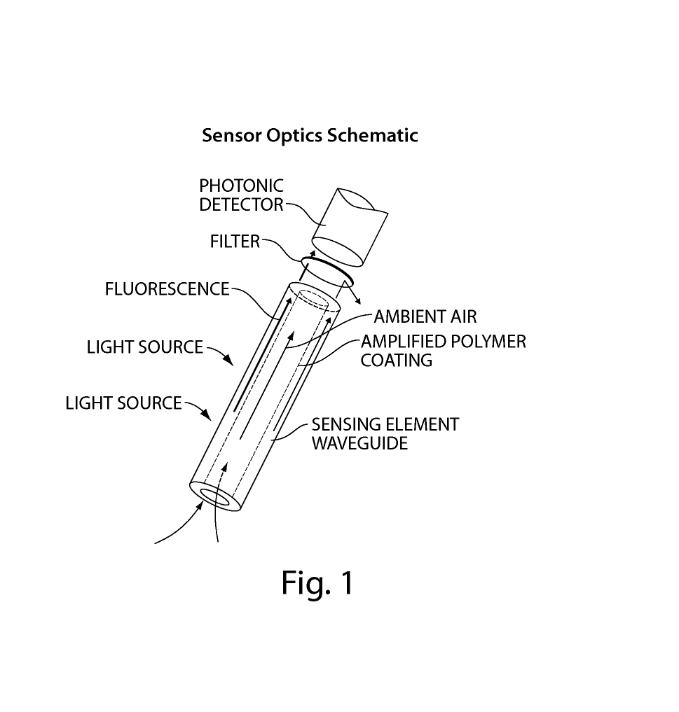

The following example describes the fabrication of a “modified” Fido® XT device, as shown in FIG. 1. A hollow bore glass capillary was functionalized with perylene molecule 1, via spin-coating or using pre-formed nanofibers of perylene molecule 1 (or N-(1-hexylheptyl)perylene-3,4,9,10-tetracarboxyl-3,4-anhydride-9,10-imide), to produce the sensing element. The synthesis of perylene molecule 1 is described in, for example, Che et al., Nano Letters 2008, 8, 2219-2223. The sensing element (SE) was positioned to be excited by two 405-nm LEDs normal to the SE. The resulting fluorescence may be waveguided along the capillary, may pass through an emission filter (to block out background scatter and light from the excitation source), and may be measured by a photodetector. Air samples can be pulled through the bore of the sensing element using a small pump. If target analytes are present, they can interact with the sensory material, resulting in a fluorescence quench. This transient fluorescence change can then be recorded by the photodetector and displayed for the operator in real-time.

Typical Fido® XT systems can include two independent LEDs for detection of analytes: one at the “front” of the system, referred to as “sensor 1” and another at the “back” of the system, referred to as “sensor 2.”

Using a custom-built GC-MS-Fido® setup that enables the simultaneous detection of analytes in a mass spectrometer and Fido® device, both the sensitivity and specificity of the various sensing elements may be optimized. The gas chromatograph can allow for the separation of complex sample matrices so that individual components are sequentially released based on their boiling points and/or affinity for the selected column stationary phase, permitting temporal peak correlation between the mass spectrometer and the Fido® detector response.

This GC-MS-Fido® setup can be used to triage individual sensing elements drug response. The sensing elements may be evaluated using samples of increasing complexity, including pure samples of drugs (e.g., using commercially available analytical standards in both salt and free base forms), impure “street” drug samples (e.g., analyzed directly or indirectly via SPME fiber headspace sample collection to evaluate the sensitivity and specificity of the coatings towards the various components present in the drug sample), and interferents.

### Example 2

In the following example, detection of analytically pure drugs was performed using swipe-testing in the lab. Aliquots of drug analytical standards in methanol were deposited onto Teflon swipes. The swipes were dried and analyzed using a “modified” Fido® XT system, which included a sensor material containing perylene molecule 1. A wide range of analytes were tested, including amphetamine, methamphetamine, morphine, and delta-9 THC, using various dose levels (e.g., Dose A, Ax2, Ax4, Ax8, Ax16, Ax32, Ax64, Ax128).

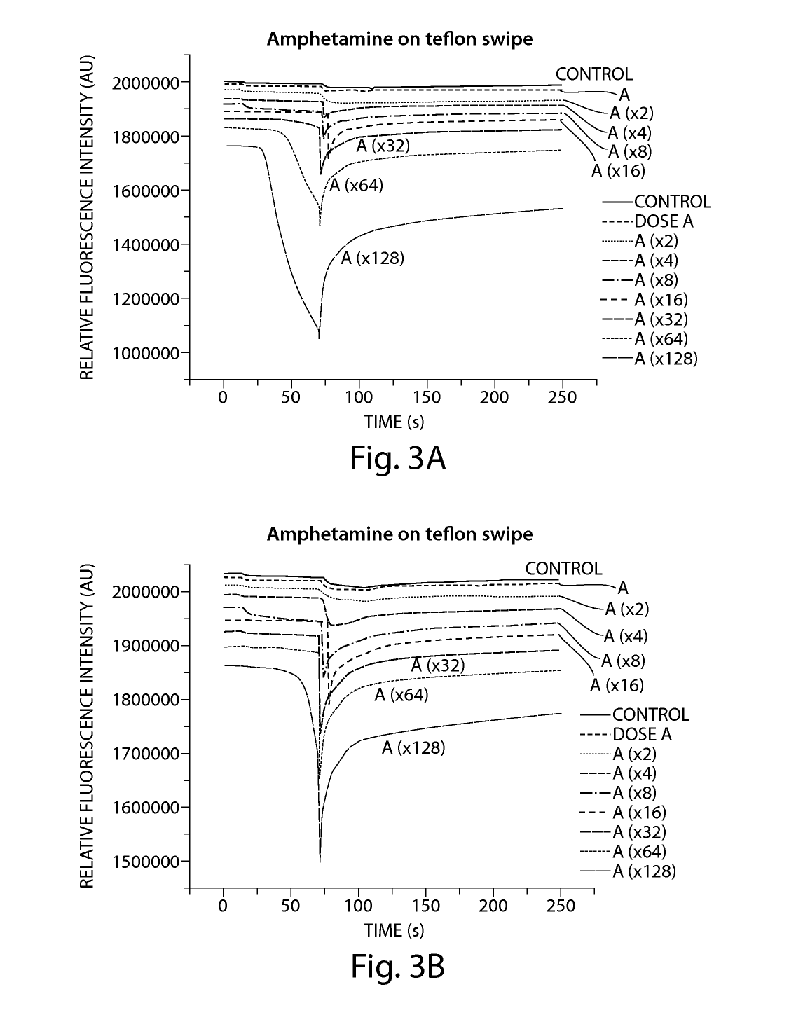

FIG. 3 shows representative data for the fluorescence response of the “modified” Fido® XT system to amphetamine, using (a) “sensor 1” and (b) “sensor 2” of the system.

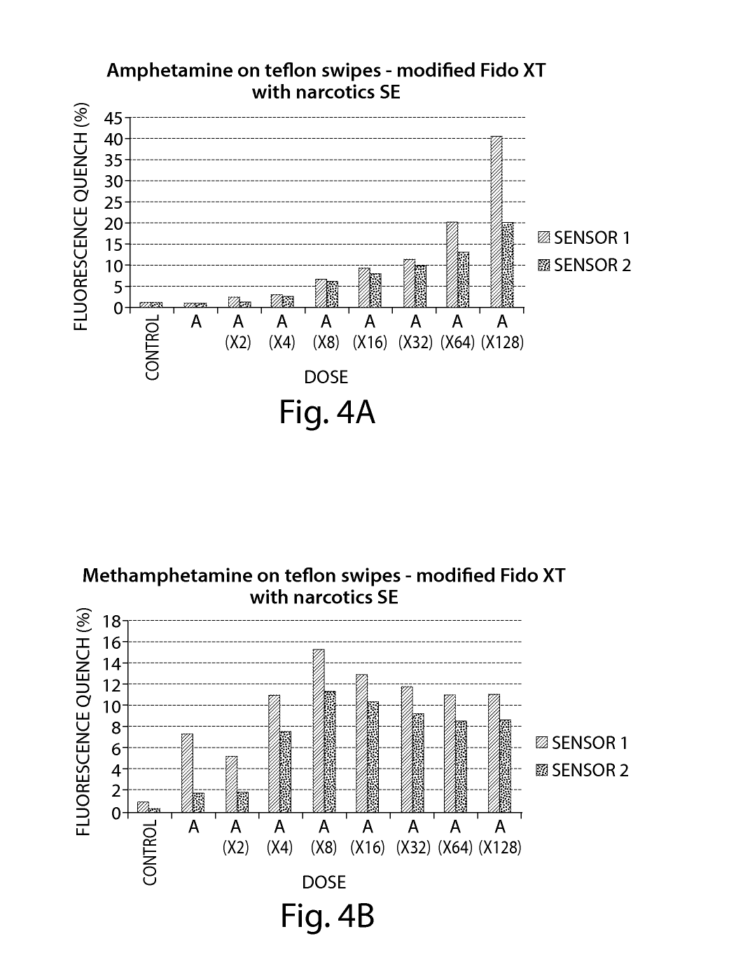

FIG. 4 show graphs summarizing the fluorescence response for swipe-based detection of (a) amphetamine and (b) methamphetamine.

### Example 3

In the following example, detection of analytically pure drugs was performed using a gas chromatograph/mass spectrometer/“modified” Fido® XT system in the lab. This GC-MS-Fido® setup enables the simultaneous detection of analytes in a mass spectrometer and a Fido® device. The GC allows for separation of complex sample matrices so that individual components are sequentially released based on boiling points and/or affinity for the selected column stationary phase, permitting temporal peak correlation between the mass spectrometer and the Fido® detector response.

A gas chromatograph was configured such that the column was plumbed from the 1079 programmable temperature vaporizing (PTV) injector back up through the 1177 standard split/split-less injector. A heated coned adapter was installed on the 1177 injector and set at 250° C. to ensure that minimal or no analyte was lost due to cold spots in the column. A “modified” Fido® XT (as described in Example 1) was positioned directly above the flow of the column for optimal detection. Aliquots of drug analytical standards in methanol were injected into the GC, split-less, with the 1079 PTV injector set at 250° C. The GC oven was initially set at 80° C., then was ramped 20° C./minute to 300° C. and held at that temperature for 2 minutes. The column flow was 1.2 mL/minute through a Restek RXi-5MS 15m by 0.25 mm ID column. Dose B, Bx5, and Bx10 of each analyte were analyzed. The GC was then plumbed so that approximately 50% of the analyte injected would be delivered between the Fido® XT and the mass spectrometer via Y-presstight and restriction columns.

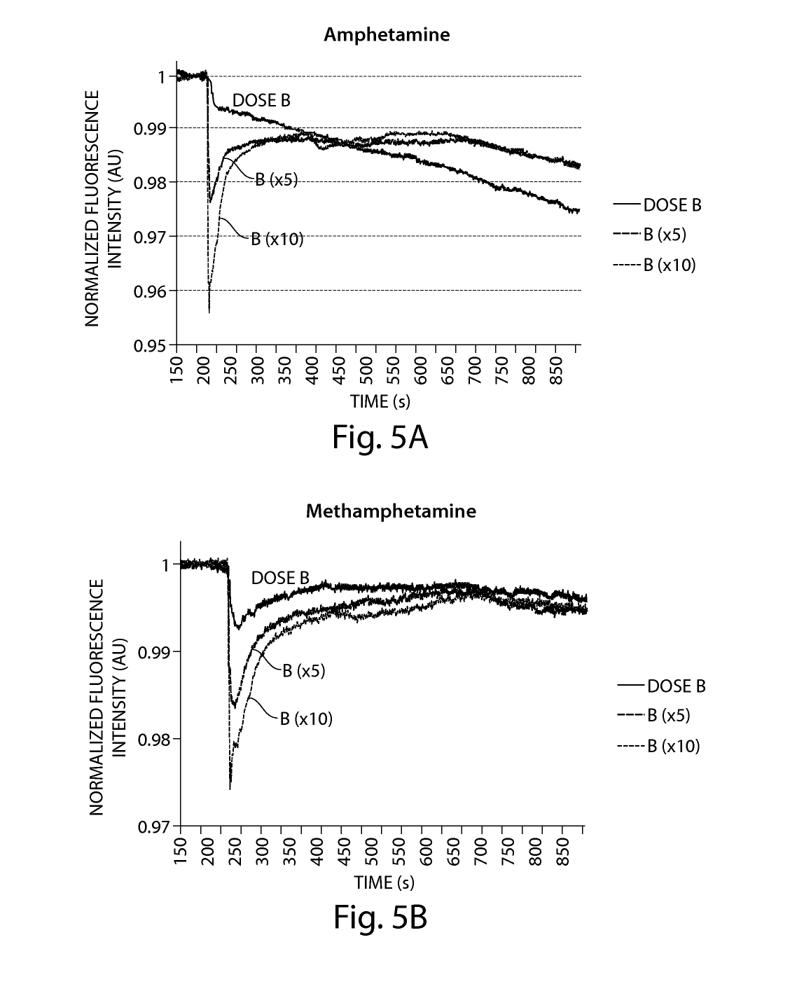

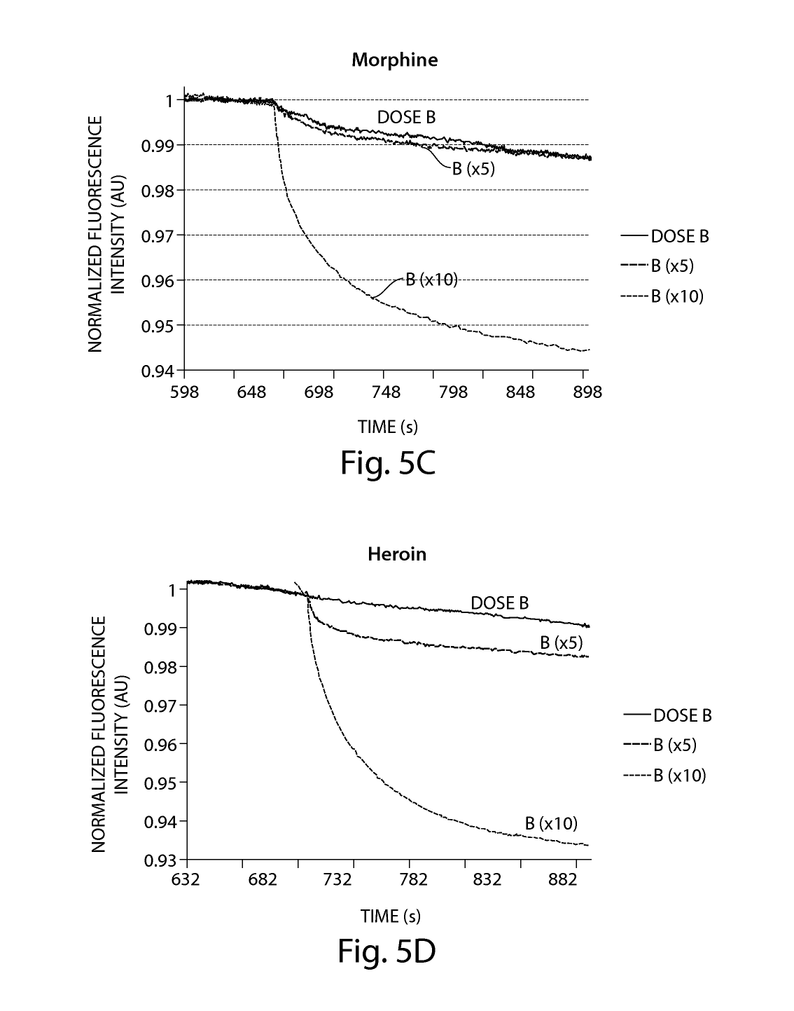

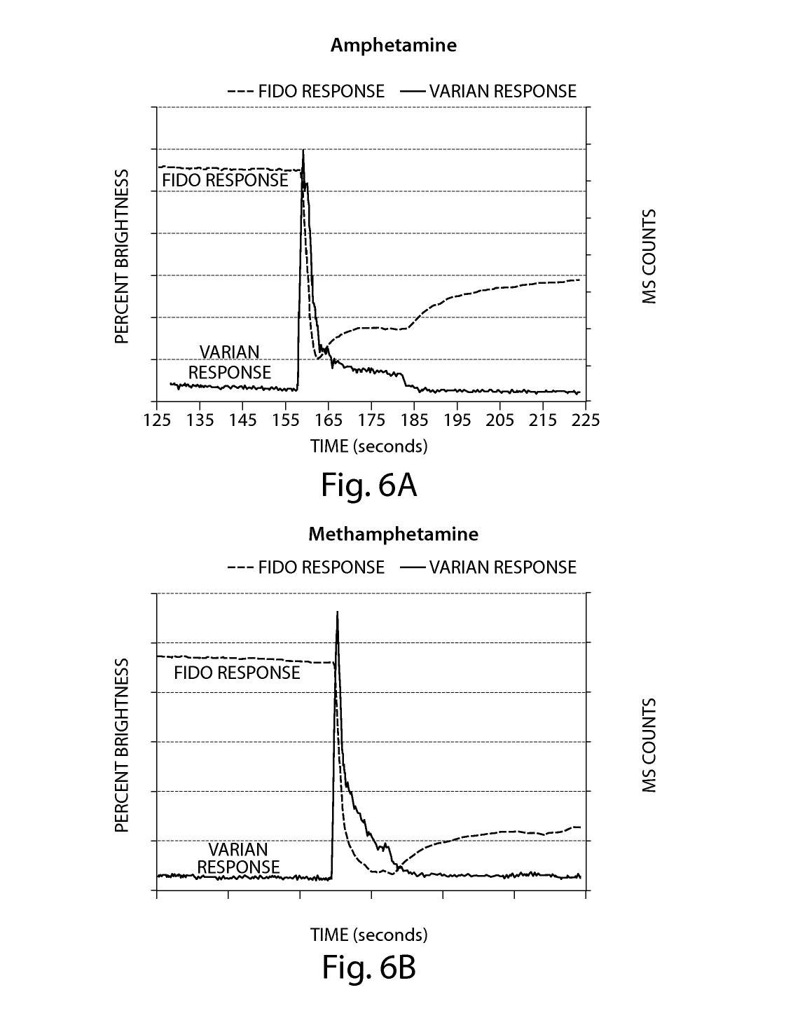

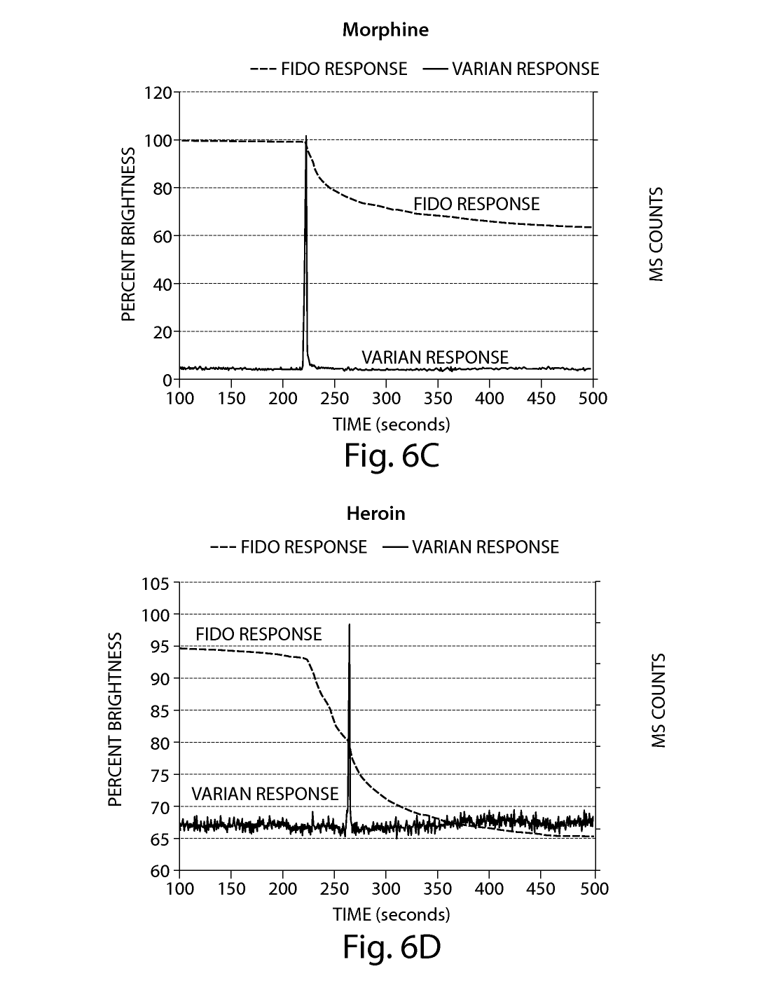

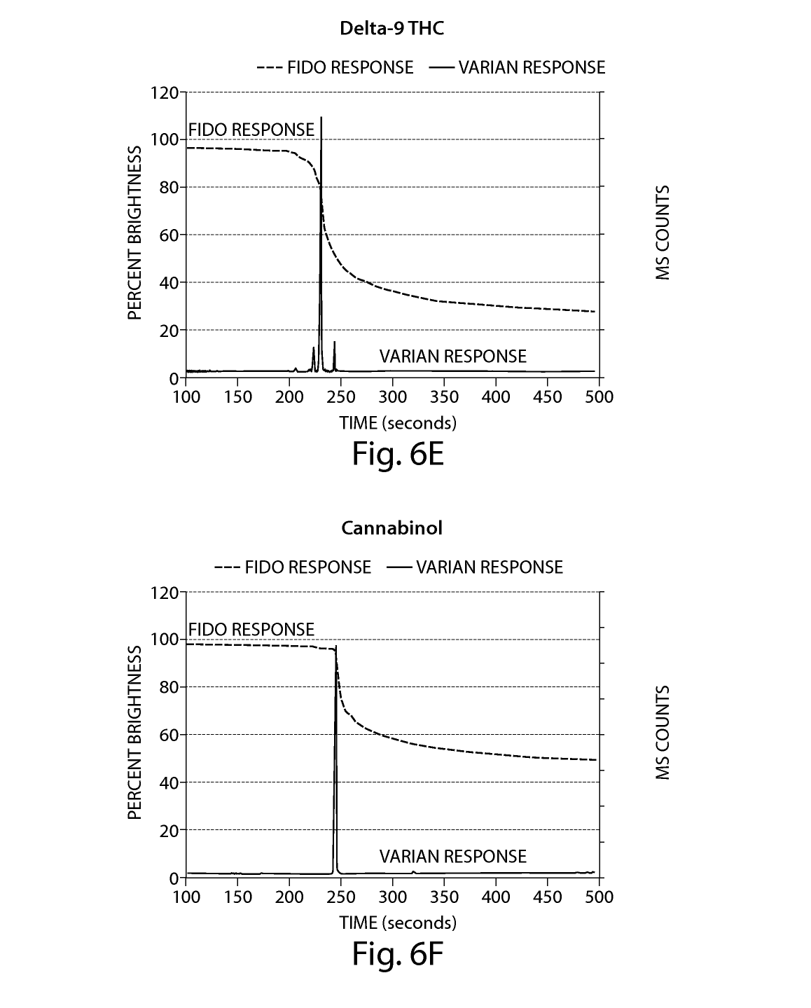

FIG. 5 shows representative data for the fluorescence response of the “modified” Fido® XT system to GC samples of (a) amphetamine, (b) methamphetamine, (c) morphine, and (d) heroin. FIG. 6 shows graphs of both the “modified” Fido® XT response and the MS data upon exposure to GC-based samples of (a) amphetamine, (b) methamphetamine, (c) morphine, and (d) heroin, (e) delta-9 THC, and (f) cannabinol.

### Example 4

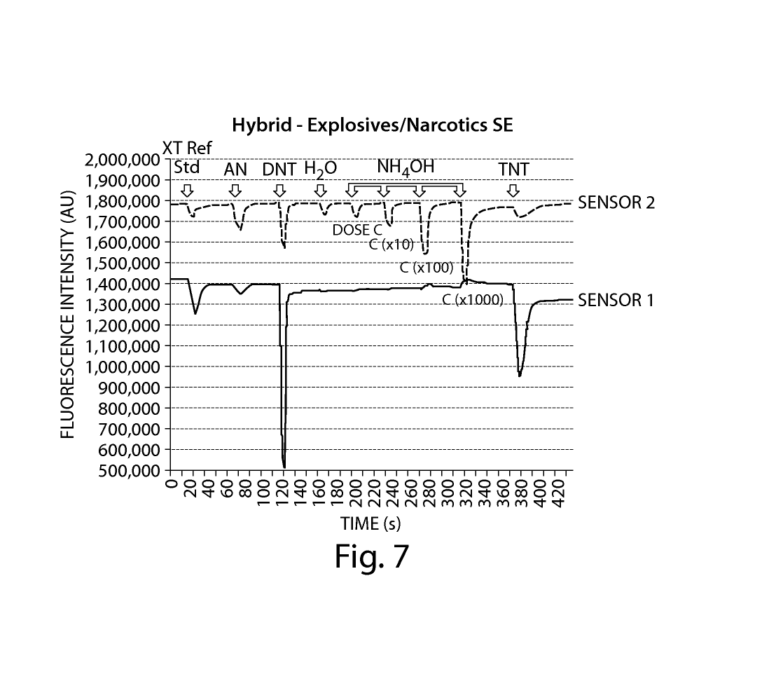

This example describes the fabrication of a “hybrid” Fido® XT system, which includes a sensing element capable of determining more than one type of analyte. In this example, a hybrid explosives-drug sensing element was fabricated by over-coating an explosives-only sensing element (e.g., a capillary coated with a sensing material for determining only explosives) with fibrils of a perylene molecule 1 (e.g., drug sensing material). The resulting “hybrid” Fido® XT system was then challenged with vapor-phase analytes including water, ammonium hydroxide, ammonium nitrate, DNT, and TNT, at various doses (e.g., Dose C, Cx10, Cx100, and Cx1000). FIG. 7 shows a graph of the fluorescence response of the “hybrid” Fido® XT system to the vapor-phase analytes.

### Example 5

This example describes the fabrication of a “hybrid” Fido® XT system, which includes two separate zones for (1) an explosives-only sensing material, and (2) a drug sensing material. In this example, the back-half coating of an explosives-only sensing element was removed and then coated with fibrils of perylene molecule 1 (e.g., drug sensing material). The resulting hybrid sensing element was placed in a Fido® XT system to form a “hybrid” Fido® XT system containing separate zones for the different sensing materials. “Sensor 1” of the system correlates to the explosives-only sensing material (“explosives channel”), while “Sensor 2” of the system correlates to the drug sensing material (“drug channel”).

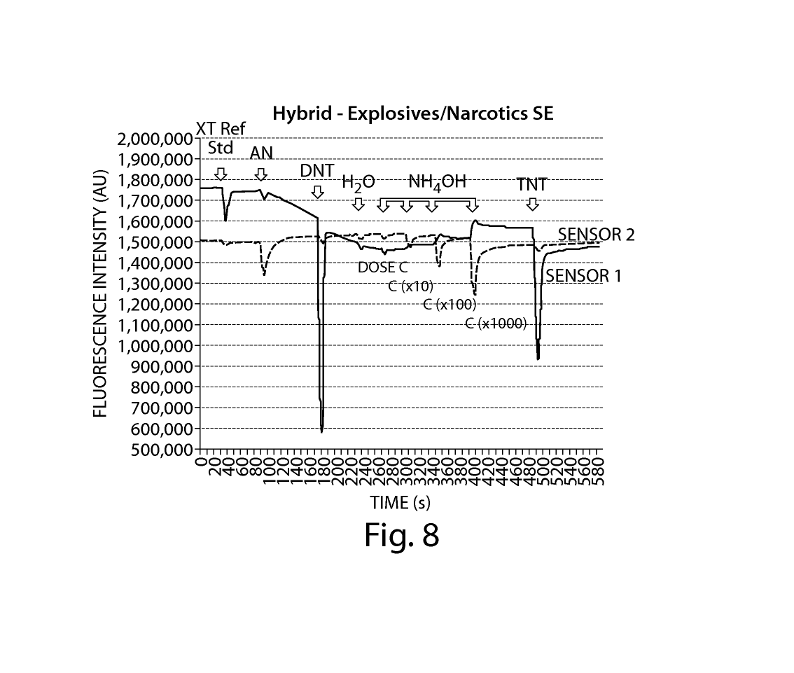

This “hybrid” Fido® XT system was then challenged with vapor-phase analytes including water, ammonium hydroxide, ammonium nitrate, DNT, and TNT, at various doses (e.g., Dose C, Cx10, Cx100, and Cx1000). FIG. 8 shows a graph of the fluorescence response of the hybrid Fido® XT system to the vapor-phase analytes.

### Example 6

This example describes the swipe-based testing of explosives using a “hybrid” Fido® XT system containing separate zones for explosives-only and drug sensing elements, as described in Example 5. Again, “Sensor 1” of the system correlates to the explosives-only sensing material (“explosives channel”), while “Sensor 2” of the system correlates to the drug sensing material (“drug channel”). Aliquots of explosive analytical standards in solvent were deposited onto Teflon® swipes, which were then dried and analyzed using the “hybrid” Fido® XT system, in conjunction with a swipe desorber. The results of the “hybrid” Fido® XT system were compared with those of an explosives-only Fido® XT system, i.e., a Fido® XT system including a sensing element for detection of explosives only.

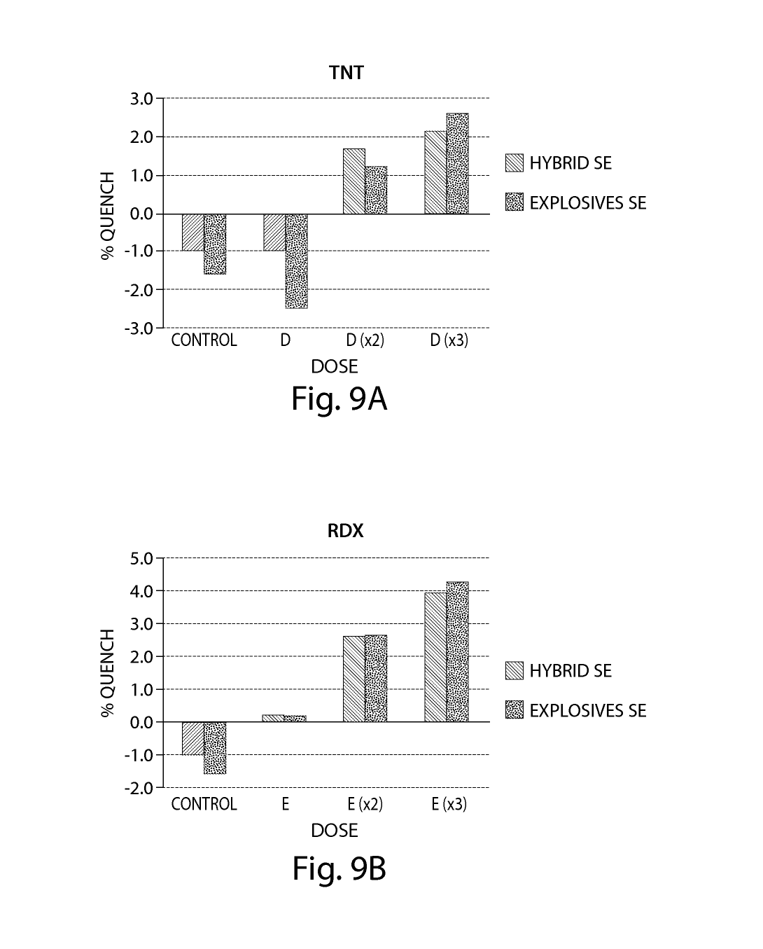

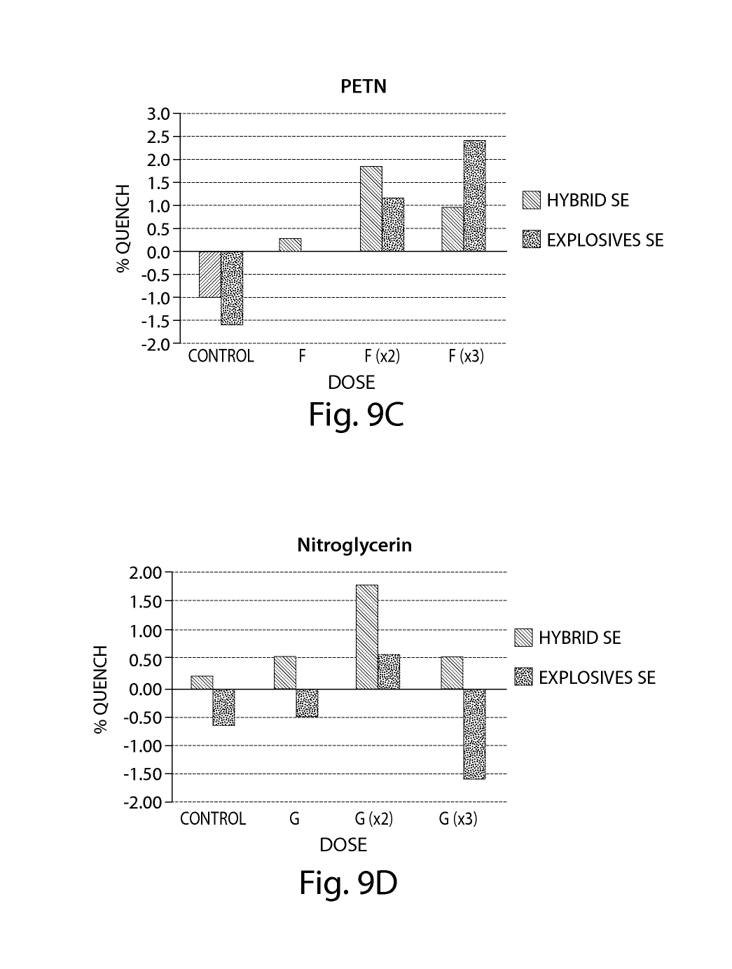

FIG. 9 shows graphs of the fluorescence response of both a “hybrid” Fido® XT system and an explosives-only Fido® XT system upon exposure to (a) TNT, (b) RDX, (c) PETN, and (d) nitroglycerin, at various doses (e.g., D, Dx2, Dx3, E, F, G, etc.).

### Example 7

This example describes the swipe-based testing of explosives using a “hybrid” Fido® XT system containing separate zones for explosives-only and drug sensing elements, as described in Example 5. Again, “Sensor 1” of the system correlates to the explosives-only sensing material (“explosives channel”), while “Sensor 2” of the system correlates to the drug sensing material (“drug channel”). Aliquots of drug analytical standards in methanol were deposited onto Teflon® swipes, which were then dried and analyzed using the “hybrid” Fido® XT system containing separate zones for explosives-only and drug sensing elements.

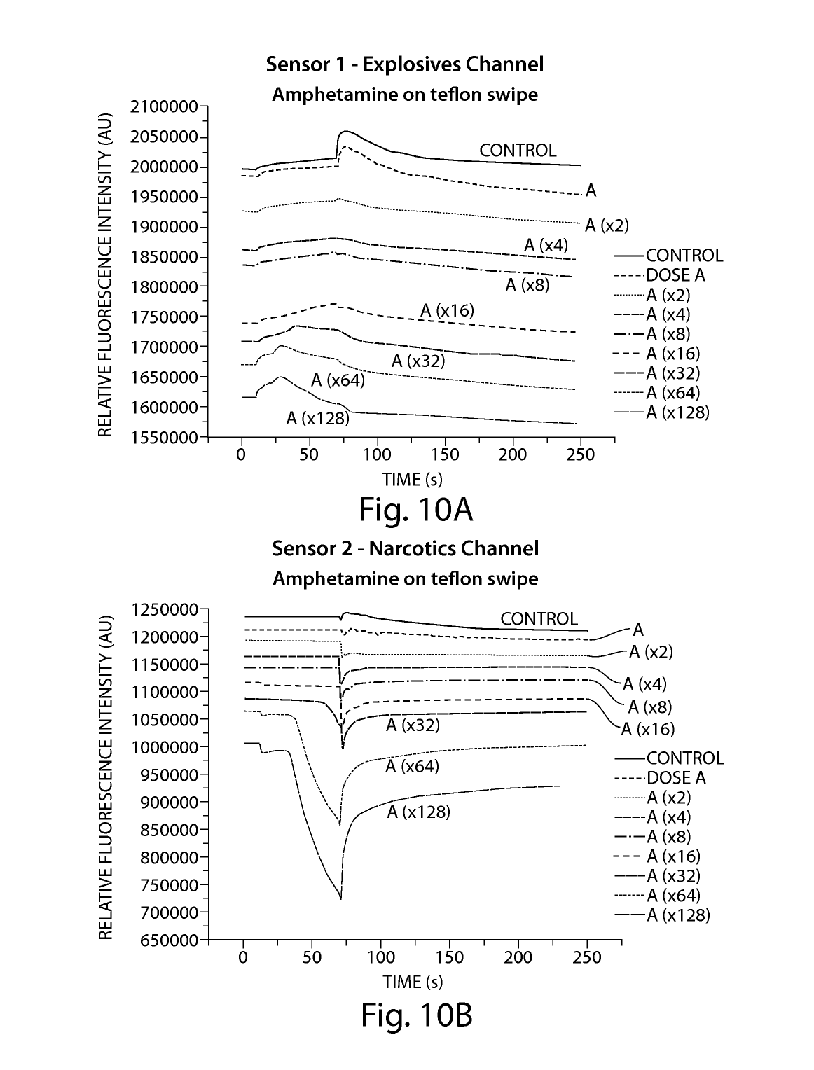

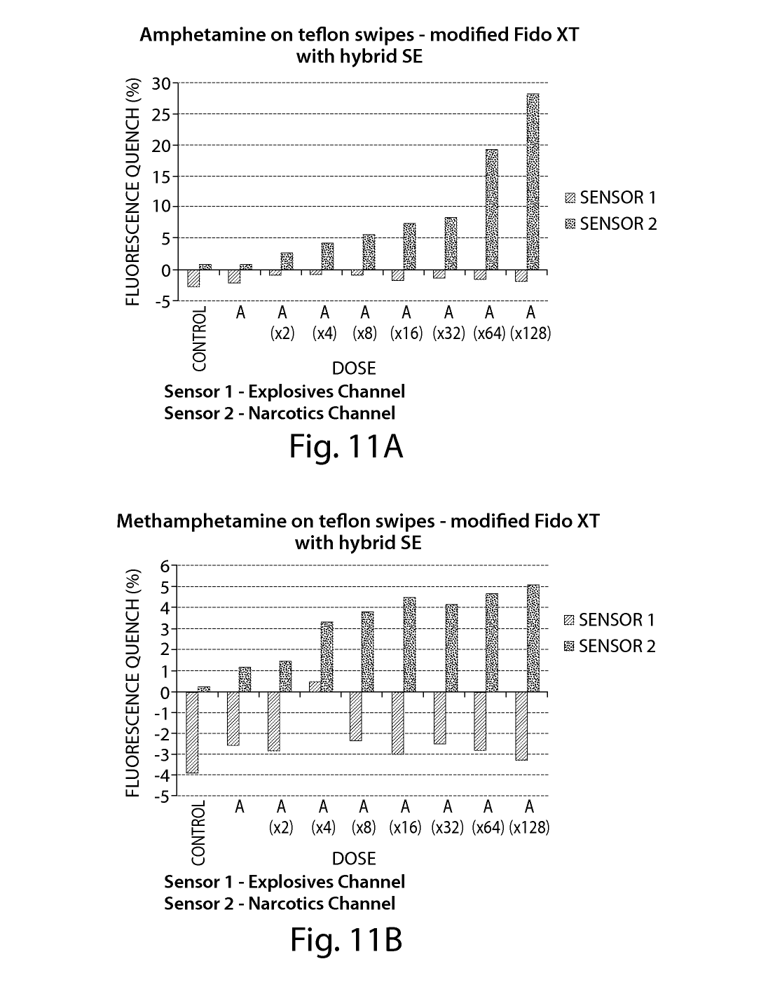

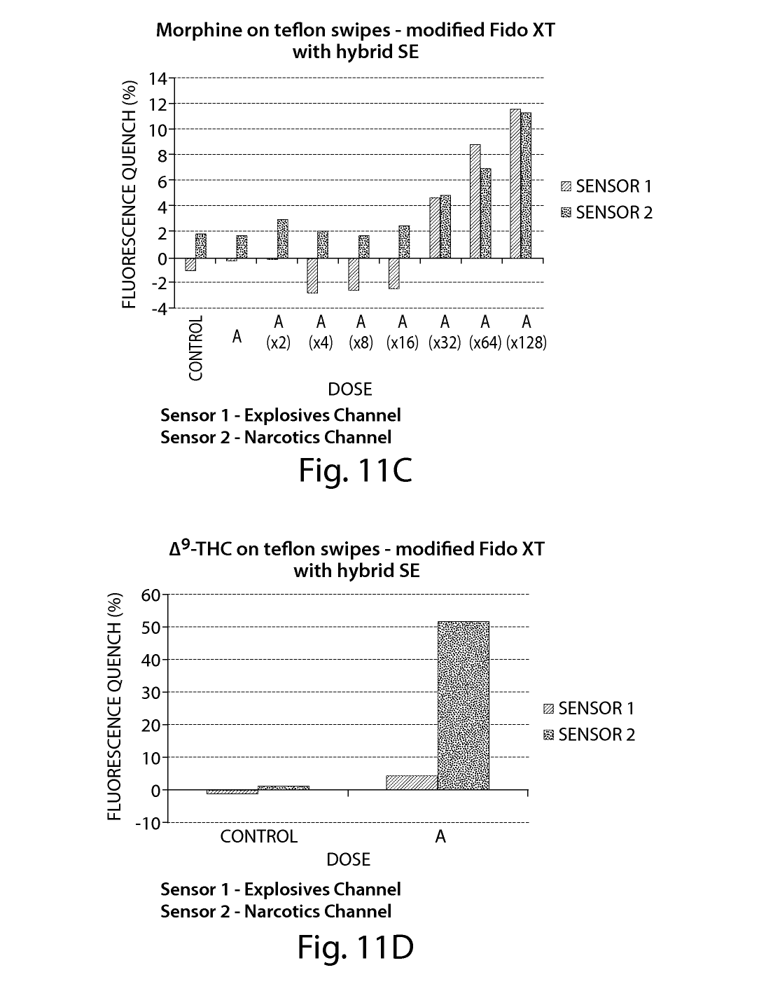

A range of drugs were evaluated, including amphetamine, methamphetamine, morphine, and delta-9 THC. FIG. 10 shows representative data for the fluorescence response of the “hybrid” Fido® XT system upon exposure to amphetamine for (a) the Sensor 1/explosives channel and (b) the Sensor 2/drug channel, at various doses. FIG. 11 shows graphs of the fluorescence response of the “hybrid” Fido® XT system upon exposure to (a) amphetamine, (b) methamphetamine, (c) morphine, and (d) delta-9 THC, using swipe-based detection.

### Example 8

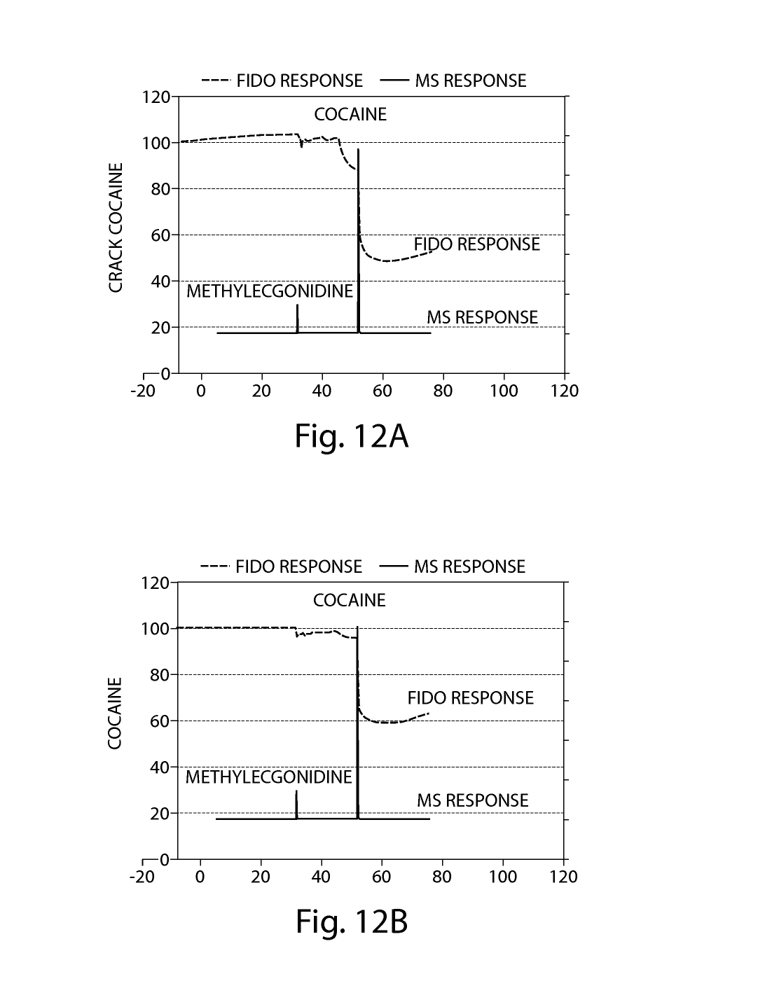

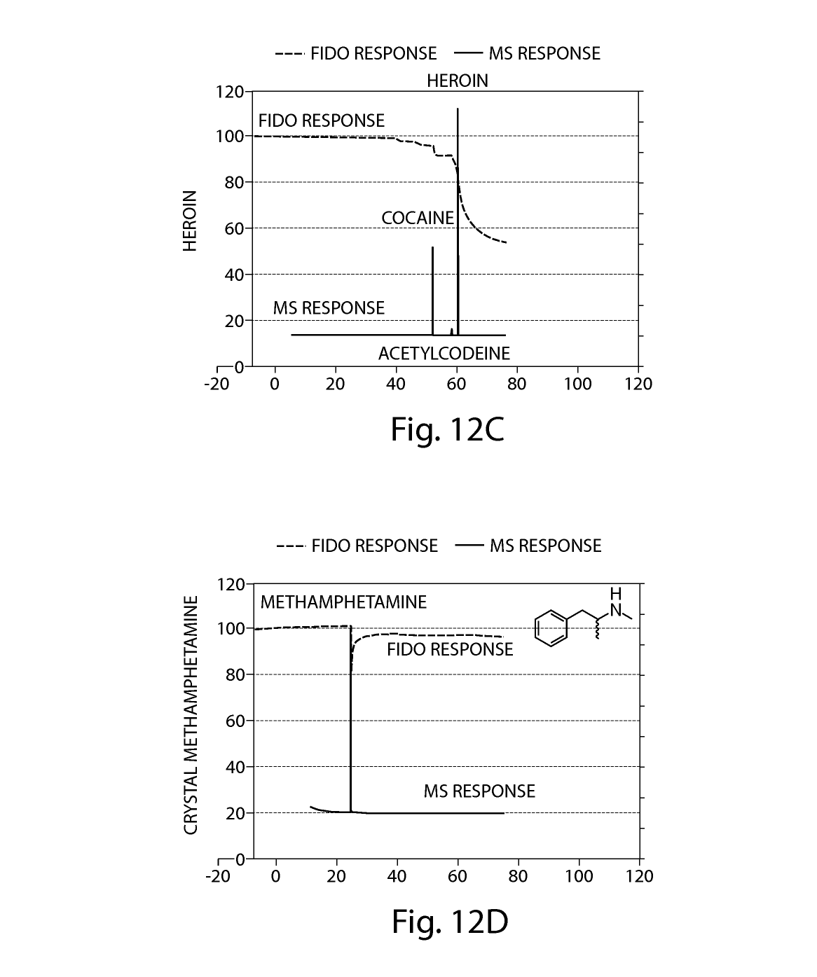

This example describes the detection of impure or “street” drugs in the laboratory, using a GC/MS “modified” Fido® XT system, as described in Example 3. Among the “street” drugs evaluated were crack cocaine, cocaine, heroin, and crystal methamphetamine. FIG. 12 shows the fluorescence response (“Fido® Response”) and mass spectrometry response (“MS Response”) of the system upon exposure to (a) crack cocaine, (b) cocaine, (c) heroin, and (d) crystal methamphetamine.

### Example 9

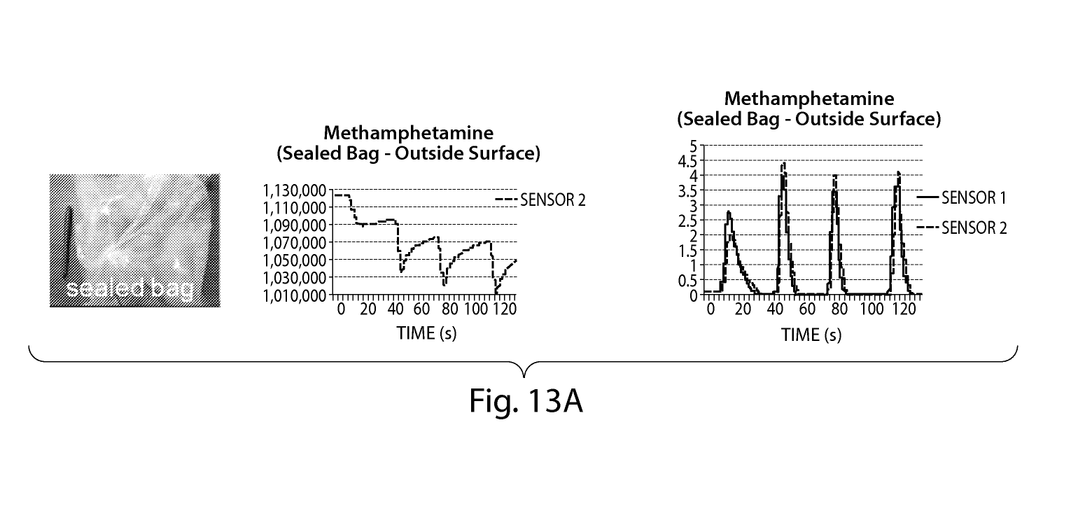

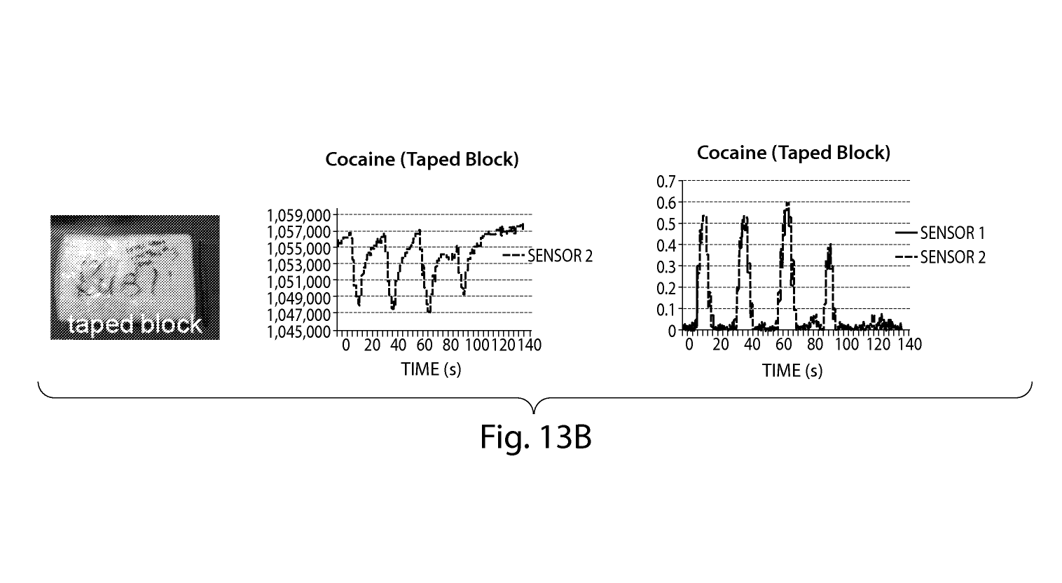

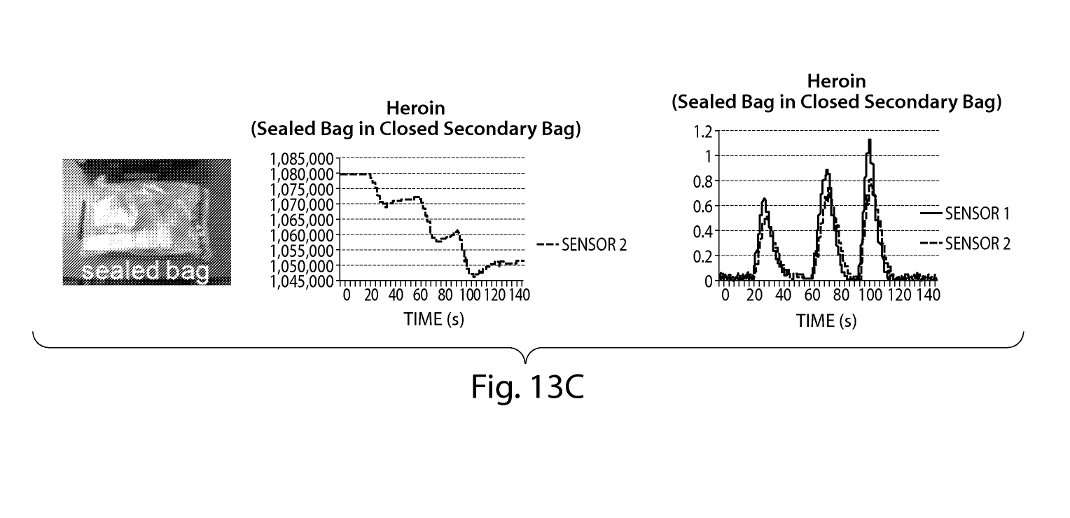

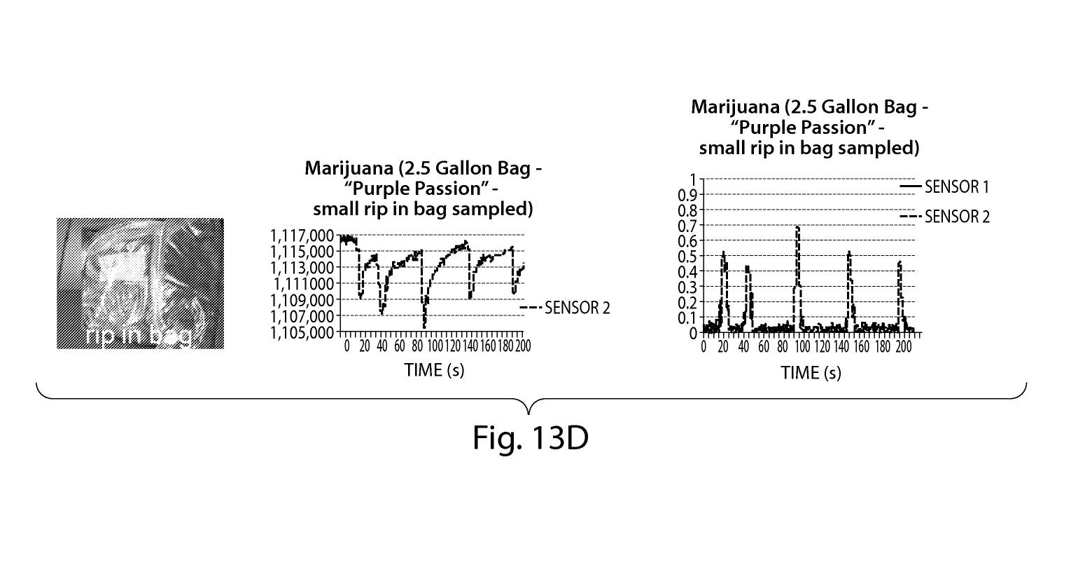

This example describes the detection of impure or “street” drugs in the field, using a “modified” Fido® XT system, as described in Example 3. The drugs can be analyzed directly or indirectly (e.g., via solid-phase microextraction (SPME) fiber headspace sample collection). Among the “street” drugs evaluated were crack cocaine, cocaine, heroin, and crystal methamphetamine. FIG. 13 shows the fluorescence response (“Fido® Response”) of the system upon exposure to (a) a sealed bag of methamphetamine, (b) a taped block of cocaine, (c) a sealed bag of heroin, and (d) a ripped bag of marijuana.

### Example 10

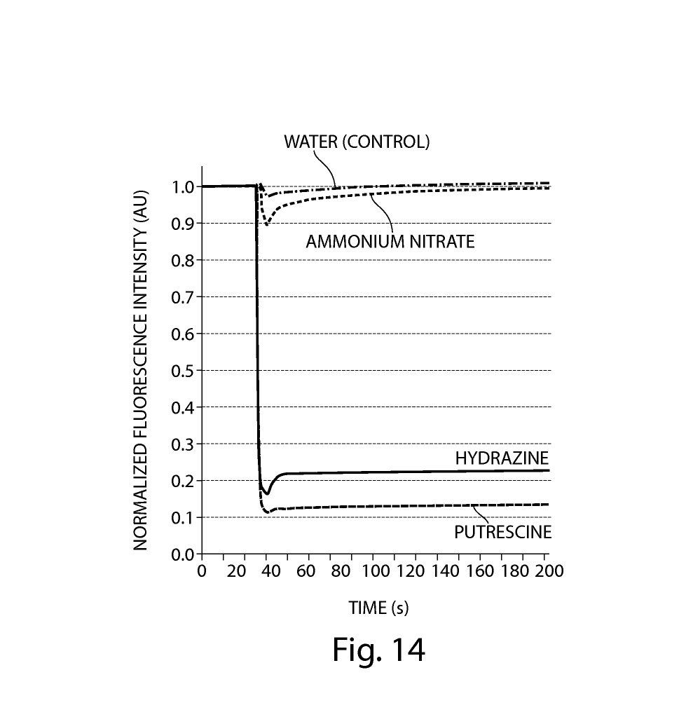

This example describes the head-space analysis of water (control), ammonium nitrate, putrescine, and hydrazine samples using a “modified” Fido® XT system with a drug sensing element. FIG. 14 shows the fluorescence response data of the “modified” Fido® XT system upon exposure to such analytes.

What is claimed:

1. A method for determination of an analyte, comprising:
exposing a luminescent sensor material to a sample suspected of containing an amine-containing analyte in vapor phase or a phenol-containing analyte in vapor phase, wherein the amine-containing analyte or the phenol-containing analyte has a vapor pressure less than 880 ppm at 25° C. and 1 atm, and, if present, causes the sensor material to generate a determinable signal; and
determining the signal.

2. A method for determination of an analyte with a sensor, comprising:
exposing, under a set of conditions, a sensor material having a first determinable signal to a sample suspected of containing an amine-containing analyte or a phenol-containing analyte, wherein the amine-containing analyte or phenol-containing analyte, if present, interacts with the sensor material to generate a second determinable signal from the sensor material, the second determinable signal being different than the first determinable signal; and
after exposing, recovering at least 50% of the first determinable signal under said set of conditions in 12 hours or less.

3. A method as in claim 1, wherein the analyte has a vapor pressure less than 500 ppm at 25° C. and 1 atm.

4. A method as in claim 1, wherein the analyte has a vapor pressure less than 250 ppm at 25° C. and 1 atm.

5. A method as in claim 1, wherein the analyte has a vapor pressure less than 100 ppm at 25° C. and 1 atm.

6. A method as in claim 2, wherein, after recovering, the sensor material is exposed to a second sample suspected of containing an amine-containing analyte or a phenol-containing analyte.

7. A method as in claim 2, wherein the second determinable signal has an amplitude that is decreased relative to the first determinable signal.

8. A method as in claim 2, wherein the second determinable signal has an amplitude that is increased relative to the first determinable signal.

9. A method as in claim 2, wherein at least 60% of the first determinable signal is recovered under said set of conditions in 12 hours or less.

10. A method as in claim 2, wherein at least 70% of the first determinable signal is recovered under said set of conditions in 12 hours or less.

11. A method as in claim 2, wherein at least 80% of the first determinable signal is recovered under said set of conditions in 12 hours or less.

12. A method as in claim 2, wherein at least 90% of the first determinable signal is recovered under said set of conditions in 12 hours or less.

13. A method as in claim 2, wherein at least 95% of the first determinable signal is recovered under said set of conditions in 12 hours or less.

14. A method as in claim 2, wherein at least 99% of the first determinable signal is recovered under said set of conditions in 12 hours or less.

15. A method as in claim 2, wherein at least 50% of the first determinable signal under said set of conditions is recovered in 10 hours or less.

16. A method as in claim 2, wherein at least 50% of the first determinable signal under said set of conditions is recovered in 5 hours or less.

17. A method as in claim 2, wherein at least 50% of the first determinable signal under said set of conditions is recovered in 1 hour or less.

18. A method as in claim 2, wherein at least 50% of the first determinable signal under said set of conditions is recovered in 30 minutes or less.

19. A method as in claim 2, wherein at least 50% of the first determinable signal under said set of conditions is recovered in 10 minutes or less.

20. A method as in claim 2, wherein at least 50% of the first determinable signal under said set of conditions is recovered in 5 minutes or less.

21. A method as in claim 2, wherein at least 50% of the first determinable signal under said set of conditions is recovered in 1 minute or less.

22. A method as in claim 2, wherein at least 50% of the first determinable signal under said set of conditions is recovered in 30 seconds or less.

23. A method as in claim 2, wherein at least 50% of the first determinable signal under said set of conditions is recovered in 10 seconds or less.

24. A method as in claim 2, wherein at least 50% of the first determinable signal under said set of conditions is recovered in 5 seconds or less.

25. A method as in claim 2, wherein at least 50% of the first determinable signal under said set of conditions is recovered in 1 second or less.

26. A method as in any preceding claim, wherein the amine-containing analyte or phenol-containing analyte is a drug.

27. A method as in any preceding claim, wherein the amine-containing analyte or phenol-containing analyte is a controlled substance.

28. A method as in any preceding claim, wherein the amine-containing analyte comprises hydrazine, ammonia, aniline, putrescine, cadaverine, skatole, methamphetamine, amphetamine, crack cocaine, cocaine, methylecgonidine, heroin, 3,4-methylenedioxymethamphetamine, oxycodone, morphine, psilocybin, psilocin, LSD, hydrocodone, benzodiazepine, salts thereof, or mixtures thereof.

29. A method as in any preceding claim, wherein the analyte is ammonium nitrate, or mixtures comprising ammonium nitrate.

30. A method as in any preceding claim, wherein the phenol-containing analyte comprises tetrahydrocannabinol.

31. A method as in any preceding claim, wherein the determinable signal is a fluorescence emission.

32. A method as in any preceding claim, wherein the sensor material comprises a monocyclic or polycyclic aromatic species.

33. A method as in any preceding claim, wherein the sensor material comprises a polymer.

34. A method as in any preceding claim, wherein the sensor material comprises a compound having the formula, 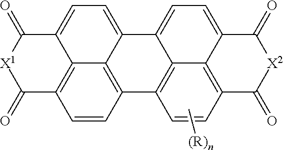
wherein:
each R is independently hydrogen, an aliphatic group, or a heteroaliphatic group, any of which is optionally substituted, or R is a group attached to a polymer;
X¹ and X² are each independently O, S, or NR¹, wherein R¹ is hydrogen, an aliphatic group, or a heteroaliphatic group, any of which is optionally substituted, or R¹ is a group attached to a polymer; and
n is 1-8.

35. A method as in any preceding claim, wherein the sensor material comprises a compound having the formula, 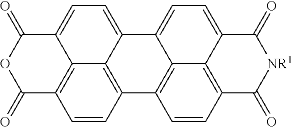
wherein R¹ is alkyl.

36. A method as in any preceding claim, wherein the sensor material comprises a compound having the formula,

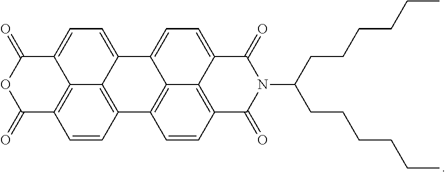 [SMILES: CCCCCCC(CCCCCC)N1C(=O)c2ccc3c4ccc5c6c(ccc(c7ccc(c2c37)C1=O)c64)C(=O)OC5=O]

37. A method as in any preceding claim, wherein the sensor material is in solid form.

38. A method as in any preceding claim, wherein the sensor material is a fibrous material.

39. A method as in any preceding claim, wherein the sensor material is formed as a thin film on a substrate.

40. A method as in any preceding claim, wherein the sensor material is supported on a support material.

41. A device, comprising:
a sample cell constructed and arranged to receive a vapor sample, the sample cell comprising a sensor material capable of interacting with an amine-containing analyte in vapor phase or a phenol-containing analyte in vapor phase, if present in the sample, to generate a determinable signal; and
a detection mechanism positioned to determine the signal,
wherein the sensor material comprises a compound having the formula, 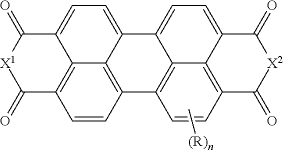
wherein:
each R is independently hydrogen, an aliphatic group, or a heteroaliphatic group, any of which is optionally substituted, or R is a group attached to a polymer;
X¹ and X² are each independently O, S, or NR¹, wherein R¹ is hydrogen, an aliphatic group, or a heteroaliphatic group, any of which is optionally substituted, or R¹ is a group attached to a polymer; and
n is 1-8.

42. A device, comprising:
a sample cell constructed and arranged to receive a vapor sample, the sample cell comprising a first region comprising a first sensor material and a second region comprising a second sensor material, wherein at least one of the first and second sensor materials interacts with an amine-containing analyte in vapor phase or a phenol-containing analyte in vapor phase, if present in the vapor sample, to generate a determinable signal; and
a detection mechanism positioned to determine the signal,
wherein at least one of the first and second sensor materials comprises a compound having the formula, 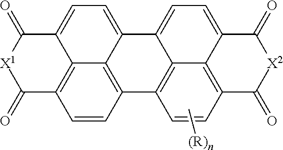
wherein:
each R is independently hydrogen, an aliphatic group, or a heteroaliphatic group, any of which is optionally substituted;
X¹ and X² are each independently O, S, or NR¹, wherein R¹ is hydrogen, an aliphatic group, or a heteroaliphatic group, any of which is optionally substituted; and
n is 1-8.

43. A device as in any preceding claim, wherein the sensor material comprises a compound having the formula, 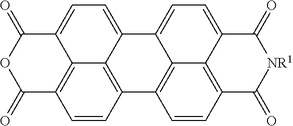
wherein R¹ is alkyl.

44. A device as in any preceding claim, wherein the sensor material comprises a compound having the formula,

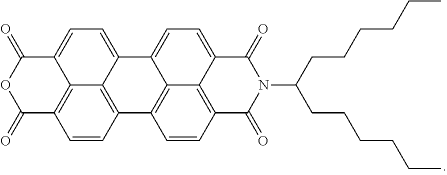 [SMILES: CCCCCCC(CCCCCC)N1C(=O)c2ccc3c4ccc5c6c(ccc(c7ccc(c2c37)C1=O)c64)C(=O)OC5=O]

45. A device as in any preceding claim, further comprising a source of energy.

46. A device as in any preceding claim, wherein the source of energy is electromagnetic radiation.

47. A device as in any preceding claim, wherein the sensor material is in solid form.

48. A device as in any preceding claim, wherein the sensor material is a fibrous material.

49. A device as in any preceding claim, wherein the sensor material is a thin film on a substrate.

50. A device as in any preceding claim, wherein the sensor material is supported on a support material.

51. A device as in any preceding claim, wherein the sensor material is evenly dispersed within the support material.

52. A device as in any preceding claim, wherein the sensor material is adsorbed and/or absorbed onto the support material.

53. A device as in any preceding claim, wherein the sensor material is covalently bonded to the support material.

54. A device as in any preceding claim, wherein the sensor material is attached to a polymer.

55. A device as in any preceding claim, wherein the sensor material has an emission spectrum between 330-1200 nm.

56. A device as in any preceding claim, wherein the sensor material has an emission spectrum between 400-700 nm.
